(19) United States
(12) Patent Application Publication
(10) Pub. No.: US 2011/0064117 A1
(43) Pub. Date: Mar. 17, 2011

(54) METHODS FOR NETWORK THROUGHPUT ENHANCEMENT

(75) Inventors: Ananth Subramanian, Singapore (SG); Xiaoming Peng, Singapore (SG); Po Shin Francois Chin, Singapore (SG)

(73) Assignee: AGENCY FOR SCIENCE, TECHNOLOGY AND RESEARCH, Singapore (SG)

(21) Appl. No.: 12/679,262

(22) PCT Filed: Sep. 19, 2008
(86) PCT No.: PCT/SG08/00357

§ 371 Date: Nov. 29, 2010

Related U.S. Application Data
(60) Provisional application No. 60/973,591, filed on Sep. 19, 2007.

(51) Int. Cl. H04L 27/28; H04B 1/713

(52) U.S. Cl. 375/135; 375/260

(57) ABSTRACT

A method for transmitting OFDM symbols by a plurality of ad-hoc radio communication devices in an ad-hoc radio communication devices' group is provided. The method includes a first ad-hoc radio communication device of the ad-hoc radio communication devices' group transmitting a first OFDM symbol in a first frequency sub-range of a frequency range selected for transmission in accordance with a frequency hopping pattern, the frequency range comprising a plurality of frequency sub-ranges, and in the same transmission time period, a second ad-hoc radio communication device of the ad-hoc radio communication devices' group transmitting a second OFDM symbol in a second frequency sub-range of the frequency range, wherein the second frequency sub-range is different from the first frequency sub-range.

The present application claims the benefit of the U.S. provisional application 60/973,591 (filed on 19 Sep. 2007), the entire contents of which are incorporated herein by reference for all purposes.

### TECHNICAL FIELD

Embodiments relate to the field of communication systems, such as ad-hoc radio communication systems, for example. By way of example, embodiments relate to a method of transmitting data, such as OFDM symbols.

### BACKGROUND

An ad-hoc radio communication group generally consists of a plurality of ad-hoc radio communication devices, wherein the communication among these devices is self-organized. The plurality of devices are able to discover each other within a range to form the communication group, and within the communication group, they can communicate with each other without the need of a central control.

Orthogonal Frequency Division Multiplexing (OFDM) is a widely used technique in ad-hoc radio communication systems. OFDM is a multi-carrier transmission technique, which divides the available frequency spectrum into many subcarriers, each one being modulated by a low data rate stream. OFDM can achieve high-speed data transmission and high spectral efficiency. So far, several of OFDM based standards have been put forward, such as the ECMA standard.

As an illustration, in the current version of the ECMA standard [1], the spectrum between 3100 to 10600 MHz has been divided into 14 frequency bands, each with a frequency bandwidth of 528 MHz. A multi-band OFDM scheme is used to transmit information. A total of 128 sub-carriers are used per frequency band. In operation, for example, a plurality of ad-hoc radio communication devices tend to operate as an ad-hoc communication group (beacon group) in a particular frequency channel. When the ad-hoc radio communication devices in a particular beacon group under normal equilibrium operation are tuned to a particular frequency channel, the devices end up using only up to three frequency bands of the available fourteen frequency bands. Moreover, a frequency band in one of the three utilized frequency bands is only used up to one-third of the time (if devices operate in respective time-frequency-codes). The above translates to low spectral usage and unutilized bands of frequencies.

Thus it can be seen that there is still a need to improve the existing standard to increase the point to point data rate as well as the overall network throughput.

### SUMMARY

In one embodiment, a method for transmitting OFDM symbols by a plurality of ad-hoc radio communication devices in an ad-hoc radio communication devices' group is provided. The method may include a first ad-hoc radio communication device of the ad-hoc radio communication devices' group transmitting a first OFDM symbol in a first frequency sub-range of a frequency range selected for transmission in accordance with a frequency hopping pattern, the frequency range including a plurality of frequency sub-ranges, and in the same transmission time period, a second ad-hoc radio communication device of the ad-hoc radio communication devices' group transmitting a second OFDM symbol in a second frequency sub-range of the frequency range, wherein the second frequency sub-range is different from the first frequency sub-range.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows an illustration of ad-hoc radio communications among ad-hoc communication devices within an ad-hoc radio communication devices' group;

FIG. 2 shows an illustration of a method to transmit OFDM symbols according to one embodiment of the invention;

FIG. 3(a) shows an illustration of a method to transmit OFDM symbols according to one embodiment of the invention;

FIG. 3(b) shows an illustration of a method to transmit OFDM symbols according to another embodiment of the invention;

FIG. 4 shows an illustration of the method as shown in FIG. 3(b) in more detail;

FIG. 5 shows an illustration of an ad-hoc radio communication device according to one embodiment of the invention;

FIG. 6 shows an illustration of a synchronization method;

FIG. 7 shows a flow diagram of the synchronization scheme as illustrated in FIG. 6;

FIG. 8 shows a flow diagram of the selection or reservation of a MAS in a frequency channel according to one embodiment of the invention;

FIG. 9 shows a flow diagram of the selection or reservation of a MAS in a frequency channel according to one embodiment of the invention;

FIG. 10 shows a flow diagram illustration the application of a counter clock for transmission of OFDM symbols according to one embodiment of the invention;

FIG. 11 shows an illustration of the back off module and protocol according to one embodiment of the invention;

FIG. 12 shows an illustration of the details of Channel Information Element (IE) according to one embodiment of the invention;

FIG. 13 shows a table showing the details of Mode Bits as giving in FIG. 12 according to one embodiment of the invention;

FIG. 14 shows an illustration of the details of Distributed Reservation Protocol (DRP) IE according to one embodiment of the invention;

FIG. 15 shows an illustration of the proposed Prioritized Channel Access (PCA) Availability IE according to one embodiment of the invention;

FIG. 16 shows an illustration of the proposed Relinquish Request IE according to one embodiment of the invention;

FIG. 17 shows an illustration of the proposed PHY Capabilities IE according to one embodiment of the invention;

FIG. 18 shows an illustration of the proposed Enhanced DRP Availability IE according to one embodiment of the invention;

FIG. 19 shows an illustration that two of the reserved bits of PHY Control register are used for TFC Offset Control;

FIG. 20 shows an illustration of the proposed Alternate Channel DRP IE according to one embodiment of the invention;

FIG. 21 shows an illustration of the proposed Alternate Channel DRP Availability IE according to one embodiment of the invention;

FIG. 22 shows an illustration of the proposed Alternate Channel PCA Availability IE according to one embodiment of the invention;

FIG. 23 shows an illustration of the proposed Channel Invitation IE according to one embodiment of the invention; and

FIG. 24 shows an illustration of the proposed Band Group Availability IE according to one embodiment of the invention;

FIG. 25 shows an illustration of an ad-hoc radio communication device according to one embodiment of the invention;

FIG. 26 shows an illustration of an ad-hoc radio communication device according to one embodiment of the invention.

### DESCRIPTION

As used herein, the term frequency band may refer to a predefined continuous frequency range, which may be used for signal transmission. In the context of this description, a frequency band may often be referred to using a (frequency) band number associated with it.

Further, the term frequency channel may refer to a combination of one or more frequency bands, and such a combination may be used for signal transmission as well. In this context, a frequency channel may or may not have a continuous frequency range. In the context of this description, a frequency channel is often referred to using a frequency channel number associated with it.

Additionally, the term band group may refer to a group of frequency bands. A band group may or may not be used for signal transmission. It should be noted that it is possible that a frequency channel may have the same frequency bands as a band group.

Still further, the term Time-Frequency Code (TFC) may include a frequency hopping pattern, wherein some patterns hop among frequency bands and some stay fixed in a single frequency band. For example, the ECMA standard specifies 3 types of TFCs: one is referred to as Time-Frequency Interleaving (TFI) where the coded information is interleaved over three frequency bands; one is referred to as two-band TFI or TFI2, where the coded information is interleaved over two frequency bands; one is referred to as Fixed Frequency Interleaving (FFI), where the coded information is transmitted on a single band. Under the ECMA standard and as used hereinafter, the terms “Time-Frequency Codes (TFC)” and “frequency hopping pattern” are synonymous with the term “frequency channel”.

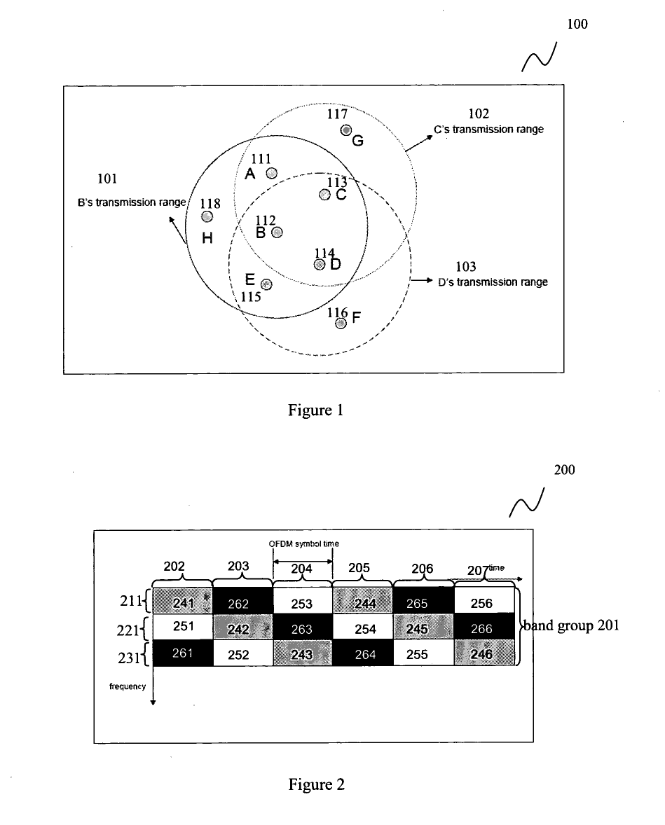

In general, in the current version of ECMA standard for OFDM transmission system, when an ad-hoc radio communication group operates in a particular frequency channel, a frequency band in a frequency band group is utilized only up to a maximum of a certain portion of the time. For example according to the current version of the ECMA standard, a frequency band is used only up to a maximum of one-third of the time if TFI is used. Further, if a device is transmitting in a particular frequency band during an OFDM symbol duration, the other bands in the band group (and possibly other band groups) are unutilized during that OFDM symbol transmission time. For example, FIG. 1 shows an illustration of an ad-hoc radio communication group 100 including devices A to H (111-118), wherein all the devices A to H (111-118) work in a particular frequency channel. For illustration, circle line 101 represents the transmission range of device B 112, meaning that device B is able to transmit OFDM symbols to other devices that are located within the circle line 101. In this illustration, device B 112 is able to transmit OFDM symbols to devices A 111, C 113, D 114, E 115, and H 118. Similarly, circle line 102 represents the transmission range of device C 113, meaning that device C is able to transmit OFDM symbols to other devices that are located within the circle line 102, and circle line 103 represents the transmission range of device D 114, meaning that device D is able to transmit OFDM symbols to other devices that are located within the circle line 103. According to the current ECMA standard, for example, when device A 111 sends OFDM symbols to device B 112, no other data transmission among the ad-hoc radio communication devices C to H (113-118) in the radio communication devices' group 100 can be carried out at the same time. Assume TFI is used. Transmission of OFDM symbols from device A 111 to device B 112 is illustrated in FIG. 2, wherein device A 111 transmits OFDM symbols to device B 112 in a frequency band group 201. The band group 201 includes three frequency bands 211, 221, and 231. When TFI is used, transmitted OFDM symbols is interleaved over three frequency bands 211, 221, and 231 according to a frequency hopping pattern, such as illustrated in the grey colored boxes 241-246. Accordingly, a frequency band is used only up to a maximum of one-third of the time during the transmission. Further, when device A 111 is transmitting data to device B 112 in a particular frequency band during an OFDM symbol duration time, the other bands in the band group are unutilized during that OFDM symbol transmission time. Thus, the spectral usage is low due to the unutilized bands of frequencies.

In one embodiment of the invention, for the ad-hoc radio communication devices in an ad-hoc radio communication devices' group to transmit OFDM symbols, a first ad-hoc radio communication device of the ad-hoc radio communication devices' group transmits a first OFDM symbol in a first frequency sub-range of a frequency range selected for transmission in accordance with a frequency hopping pattern, the frequency range including a plurality of frequency sub-ranges. In the same transmission time period, a second ad-hoc radio communication device of the ad-hoc radio communication devices' group transmits a second OFDM symbol in a second frequency sub-range of the frequency range in accordance with a time shifted version of the frequency hopping pattern, wherein the second frequency sub-range is different from the first frequency sub-range.

FIG. 2 shows an illustration of the method to transmit OFDM symbols according to one embodiment of the invention. Assume that OFDM symbols are transmitted within a band group 201 having three frequency bands 211, 221, and 231 as shown in FIG. 2. Also assume that OFDM symbols are transmitted with a frequency hopping pattern among the three frequency bands as (band 211) to (band 221) to (band 231) as shown in the grey colored boxes in FIG. 2. For example, a device will transmit a first OFDM symbol in the frequency band 211 during a first OFDM symbol time 202, transmit a second OFDM symbol in the frequency band 221 during a second OFDM symbol time 203, and transmit a third OFDM symbol in the frequency band 231 during a third OFDM symbol time 204. After this, the device will send a fourth OFDM symbol restarting from the frequency band 211 during a fourth OFDM symbol time 205, and follow the frequency hopping pattern of (band 211) to (band 221) to (band 231) in the subsequent OFDM symbol transmission. Also referring to FIG. 2, it can be seen that the black colored boxes 261-266 as well as the white colored boxes 251-256 represent the same frequency hopping pattern as the grey colored boxes 241-246, with the only exception of the starting frequency band for transmission of the first OFDM symbols. Such a difference can be also interpreted in another way: the black colored boxes 261-266 as well as the white colored boxes 251-256 respectively represent an offset of the frequency hopping pattern, or a time shifted version of the frequency hopping pattern represented by the grey colored boxes 241-246. For example, the black colored boxes 261-266 represent a time shifted version of the frequency hopping pattern relative to the frequency hopping pattern represented by the grey colored boxes 241-246. Similarly, the white colored boxes 251-256 represent a still larger time shifted version of the frequency hopping pattern relative to the frequency hopping pattern represented by the grey colored boxes 241-246. A first ad-hoc radio communication device of the ad-hoc radio communication devices' group (not shown) may transmit a first OFDM symbol within a first frequency band 211 during a first OFDM symbol transmission time 202 (see grey colored box 241 in FIG. 2). In the same transmission time period 202, a second ad-hoc radio communication device may transmit a second OFDM symbol in a second frequency band 221 (see white colored box 251 in FIG. 2), wherein the second frequency band 221 is different from the first frequency band 211.

In a further embodiment, in the same transmission time period, a third ad-hoc radio communication device of the ad-hoc radio communication devices' group may transmit a third OFDM symbol in a third frequency sub-range, wherein the third frequency sub-range is different from the first and second frequency sub-ranges.

This embodiment is also illustrated in FIG. 2. In the same transmission time period 202 of the first and second OFDM symbols transmitted by two separate devices, a third ad-hoc radio communication device (not shown) may transmit a third OFDM symbol in a third frequency band 231 (see black colored box 261 in FIG. 2), wherein the third frequency band 231 is different from the first frequency band 211 and second frequency band 221.

It thus can be seen that the entire band group may be utilized at the same time. For example, in FIG. 2, the grey colored boxes 241-246 constitute TFC offset 0, the black colored boxes 261-266 constitute TFC offset 1, and white colored boxes 251-256 constitute TFC offset 2. Here, TFC offset 0, TFC offset 1, and TFC offset 2 are within a same frequency channel (same frequency hopping pattern) and are three offsets of the frequency channel that can be used for transmission of OFDM symbols. TFC offset 1 and TFC offset 2 have a frequency shifting with respect to TFC offset 0 within the same hopping pattern. TFC offset 1 has a time shifted version of the frequency hopping pattern relative to TFC offset 0, and TFC offset 2 has a still larger time shifted version of the frequency hopping pattern relative to TFC 0. Now, refer to FIG. 1. If a device A 111 sends OFDM symbols to device B 112 using TFC offset 0, device C 113 would be able to send OFDM symbols to device D 114 simultaneously using TFC offset 1. Similarly, device E 115 would be able to send OFDM symbols to device F 116 at the same time using TFC offset 2. Hence up to three transmissions can go on simultaneously, thereby increasing the network throughput up to three times using a single band group compared with the current standard, such as the ECMA standard.

In another embodiment, a first ad-hoc radio communication device of an ad-hoc radio communication devices' group transmits a first OFDM symbol in a first frequency sub-range of a frequency range selected for transmission in accordance with a frequency hopping pattern, the frequency range comprising a plurality of frequency sub-ranges. In the same transmission time period, a second ad-hoc radio communication device of the ad-hoc radio communication devices' group transmits a second OFDM symbol in a second frequency sub-range of the frequency range in accordance with a time shifted version of the above same frequency hopping pattern, wherein the second frequency sub-range is different from the first frequency sub-range. In one embodiment, the frequency hopping pattern is with reference to a fixed point in time such as the start of a beacon slot or the start of a Medium Access Slot. In a further embodiment, in the same transmission time period, a third ad-hoc radio communication device of the ad-hoc radio communication devices' group transmits a third OFDM symbol in a third frequency sub-range of the frequency range in accordance with a still larger time shifted version of the above same frequency hopping pattern, wherein the third frequency sub-range is different from the first and second frequency sub-ranges.

It should be noted that the hopping pattern is not limited to the pattern as shown in FIG. 2, and the number of frequency bands within a band group is also not limited to the number of bands show in FIG. 2.

In addition to the effects given above, if an ad-hoc radio communication device has, for example, three Radio Frequency (RF) chains (one of the proposed three chains being optional), the ad-hoc radio communication device within the ad-hoc radio communication group will be able to have the capability to transmit an OFDM symbol in one frequency band and receive in at least one other frequency band simultaneously another OFDM symbol from another ad-hoc radio communication device. As an example, in FIG. 1, assume device B 112 has three RF chains, and is transmitting an OFDM symbol using TFC offset 0. Then at the same time period of the transmission of an OFDM symbol, device B 112 is also able to receive at up to two OFDM symbols from up to two devices using TFC offset 1 and TFC offset 2 with two other RF chains.

It should be noted however, that the number of OFDM symbols that can be transmitted in a same transmission time period is not limited to the illustration shown in FIG. 2. The number to OFDM symbols that can be transmitted in a same transmission time period will only be limited to the number to frequency sub-ranges (bands) within the frequency range (band group). For example, for a band group with n frequency bands (sub-ranges), there can be a number of up to n OFDM symbols being transmitted in a same transmission time period.

The embodiments shown above can also be easily extended to, for example, the OFDM transmission system using dual carrier TFCs or even multi-carrier TFCs. Briefly, according to the dual carrier TFCs, two OFDM symbols are transmitted in two frequency sub-ranges at a same OFDM transmission time in accordance with a frequency hopping pattern, the frequency range including a plurality of frequency sub-ranges. According to one embodiment of the invention, within an ad-hoc radio communication devices' group, a first ad-hoc radio communication device of an ad-hoc radio communication devices' group transmits a plurality of at least two OFDM symbols in a first plurality of at least two frequency sub-ranges selected for transmission in accordance with a frequency hopping pattern, the frequency range including a plurality of frequency sub-ranges. In the same transmission period, a second ad-hoc radio communication device of the ad-hoc radio communication group transmits a plurality of at least two OFDM symbols in a second plurality of at least two frequency sub-ranges, wherein the second plurality of frequency sub-ranges has no overlap with the first plurality of frequency sub-ranges.

In one embodiment, all the ad-hoc radio communication devices in the ad-hoc radio communication group are synchronized. In one embodiment, ad-hoc radio communication devices may start their OFDM symbol transmission at a same time. For example, for the ECMA standard based system, all the ad-hoc radio communication devices may start their OFDM symbol transmission at the Beacon Period Start Time (BPST) of the slowest neighbor device or the average of the BPSTs of all the devices in an ad-hoc radio communication group. In one embodiment, an ad-hoc radio communication device may start its OFDM symbol transmission during the Beacon Period at the start of the device's beacon slot. In this regard, Beacon Period (BP) may be defined as a period of time declared by a device during which it sends or listens for beacons according to the ECMA standard, and the term beacon may refer to information regarding such as the reservation of time slots in the further data period. Each superframe starts with a BP, which extends over one or more contiguous Medium Access Slots (MASs). The start of the first MAS in the BP, and the superframe, is called the Beacon Period Start Time (BPST). As background information, under the ECMA standard, frame is defined as unit of data transmitted by a device, and a superframe is the basic timing structure for frame transmissions. A superframe is composed of 256 MASs, and a superframe includes a BP followed by a data period. In one embodiment, an ad-hoc radio communication device may start its OFDM transmission in a MAS in the data period at the start of that MAS. A BP comprises a number of beacon slots, and a beacon can be transmitted within a beacon slot.

In the embodiment that all the ad-hoc radio communication devices are synchronized, there are two further options for the method of transmitting OFDM symbols according to a further embodiment of the invention. The options will be illustrated based on the ECMA standard.

According to one embodiment, if a maximum integer number of n OFDM symbols can be transmitted during a unit time, then every (n+1)th OFDM symbol from the first starts at integer values of each unit time.

For example, for the ECMA standard specified system, an OFDM Symbol Transmission Duration (OSTD) may be 312.5 ns+9.47 ns=321.97 ns, wherein an OFDM symbol transmission time of 312.5 ns and a band switching time of 9.47 ns is included. In one embodiment, an OFDM symbol is transmitted only during an OSTD. It thus can be seen that a maximum integer value of three OFDM symbols can be transmitted within one microsecond. According to one embodiment, every first to third OFDM symbols from the first transmission are transmitted continuously, and every fourth OSTD from the first transmission starts at integer values of microseconds.

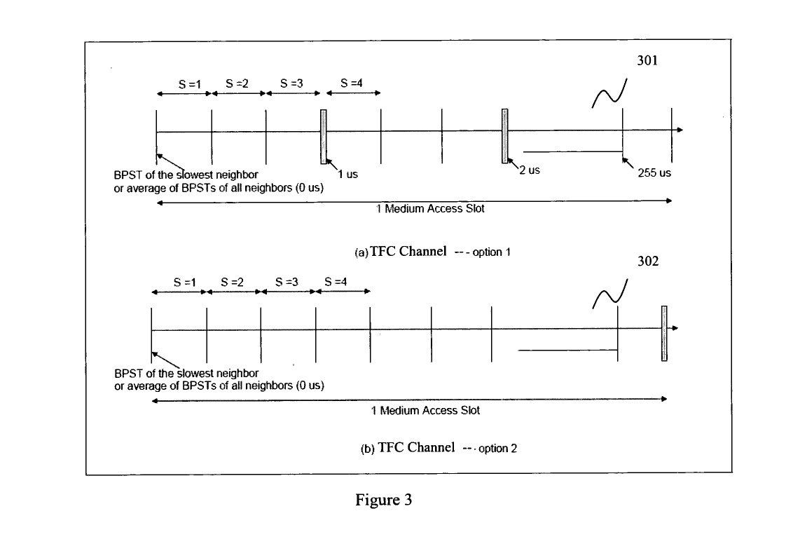

FIG. 3(a) shows an illustration of this embodiment for transmitting OFDM symbols according to one embodiment of the invention. As can be seen, the first OSTD starts at average of the BPSTs of all the devices or BPST of the slowest device, the second OSTD starts at the end of the first, and the third OSTD starts at the end of the second. Further, the fourth OSTD starts at the beginning of the next integer valued microsecond. Therefore, under the ECMA standard wherein a Medium Access Slot (MAS) includes 256 microseconds, there can be 256×3=768 OSTDs during a MAS, if the first OSTD starts at the start of the MAS. For example, for TFC offset 0 of FIG. 2, an OFDM symbol may be transmitted in band 211 in the first OSTD 202 of a MAS (grey colored box 241), a second OFDM symbol in band 221 starts to be transmitted in the second OSTD 203 of the MAS (grey colored box 242) right after the end of the first OSTD 202, a third OFDM symbol in band 231 starts to be transmitted in the third OSTD 204 of the MAS (grey colored box 243) right after the end of the second OSTD 203, and a fourth symbol in band 211 is transmitted in the fourth OSTD 205 at the beginning of a next integer valued microsecond of the MAS and so on. The first OSTD of the next MAS is scheduled to begin at the beginning of the next MAS. This option can be made backward compatible to the ECMA (current version) specification with few changes.

According to a second option, all the OFDM Symbol Transmission Durations (OSTD) may be aligned continuously without time gap according to one embodiment of the invention.

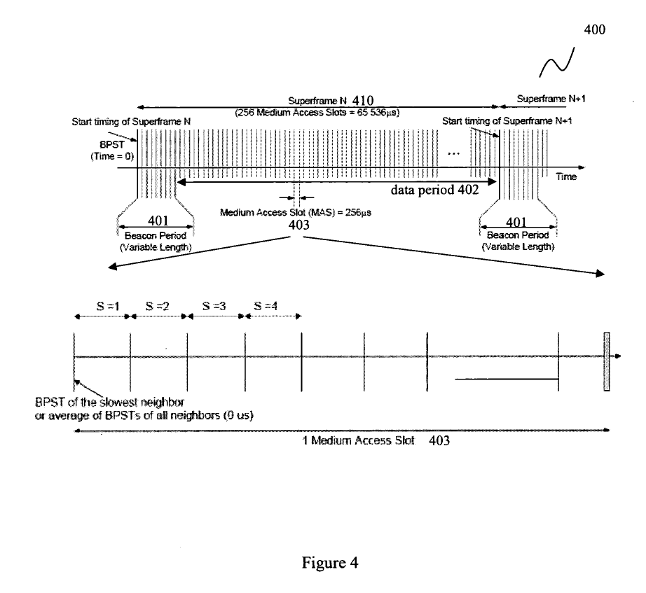

This option is illustrated in FIG. 3(b) also based on the ECMA standard. In this implementation, all the OSTDs are aligned contiguously, and hence there is no time gap between every third and fourth OSTD from the beginning of the MAS. One OSTD follows right after its previous OSTD as illustrated in FIG. 3(b). ‘S’ represents an OSTD in FIG. 3, and the second OSTD (S=2) follows right after the first OSTD (S=1). The third OSTD (S=3) follows right after the second OSTD (S=2), and the fourth OSTD (S=4) follows right after the third OSTD (S=3) and so on. Since a MAS length is 256 microseconds, a number of 795 OSTDs can be transmitted within each MAS, and some small time is left over at the end of the MAS. The first OSTD of the next MAS is scheduled to begin at the beginning of the next MAS. This option is illustrated also in FIG. 4, wherein the structure of superframe 410 according to the ECMA standard is also shown. According to the ECMA standard, a superframe is defined as periodic time interval used in the ECMA standard to coordinate frame transmissions between devices, which contains a beacon period 401 followed by a data period 402, wherein frame is defined as unit of data transmitted by a device. A superframe is composed of 256 MASs 403. According to a further embodiment, if the band switching time can be set as 9.51 ns, then the length of an OSTD is 322.01 ns, and there can be 795 OSTDs in a MAS slot. However, it should be noted that the OFDM symbol transmission time and band switching time are not limited to the illustrated values herein.

According to one embodiment, the first band of TFC offset 0 may start at a MAS boundary and TFC offset 1 and TFC offset 2 may also start at the same MAS boundary. Any ad-hoc radio communication device hearing an ongoing transmission can easily identify the TFC offset by just finding the band used in a particular OSTD in a particular MAS.

Two options for selecting frequency sub-range for transmission in accordance with a frequency hopping pattern are proposed.

According to one embodiment, an ad-hoc radio communication device may select a default frequency sub-range of a frequency range selected for transmission in accordance with a frequency hopping pattern. This embodiment is illustrated also based on the ECMA standard. For example, within an ad-hoc radio communication group, an ad-hoc radio communication device may always choose the default offset, such as TFC offset 0 for transmitting beacons (FIG. 2), wherein at the beginning of the transmission, the default frequency sub-range is frequency band 211. Note that in this first option, the number of devices that can be supported in a beacon group is limited to the number of available time slots (beacon slots as specified in the ECMA standard), as is the case in current ECMA specification.

According to another embodiment, an ad-hoc radio communication device may select a random frequency sub-range of a frequency range selected for transmission in accordance with a frequency hopping pattern. This embodiment can be illustrated also based on the ECMA standard. For example, within an ad-hoc radio communication devices' group, an ad-hoc radio communication device may always choose a random or any fixed TFC offset, either TFC offset 0, TFC offset 1, or TFC offset 2, for transmitting beacons, and the frequency sub-range at the beginning of the transmission can be either frequency band 211, frequency band 221, or frequency band 231 (FIG. 2).

Under this option, for the example shown in FIG. 2, the number of devices that can be supported can be up to a maximum of three times the number of available time (beacon) slots. Moreover, transmission (beacon) collisions may also be reduced, since any two devices will send OFDM symbols (beacons) with lower probability in a same TFC offset in the same time (beacon) slot, compared to the case where only one default channel (no use of offsets) is available to the device for transmitting OFDM symbols (beacons).

Also under this option, the usage of TFC offsets, such as TFC offset 0, TFC offset 1, TFC offset 2 shown in FIG. 2, may require the OSTDs of devices to be aligned and synchronized to each other to nanoseconds level. A device may be required to align the transmission of an OFDM symbol at only the beginning of any OSTD.

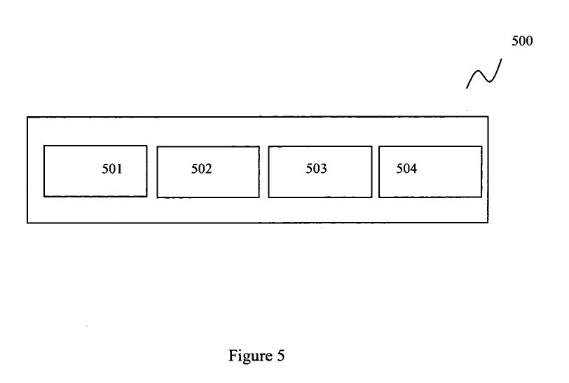

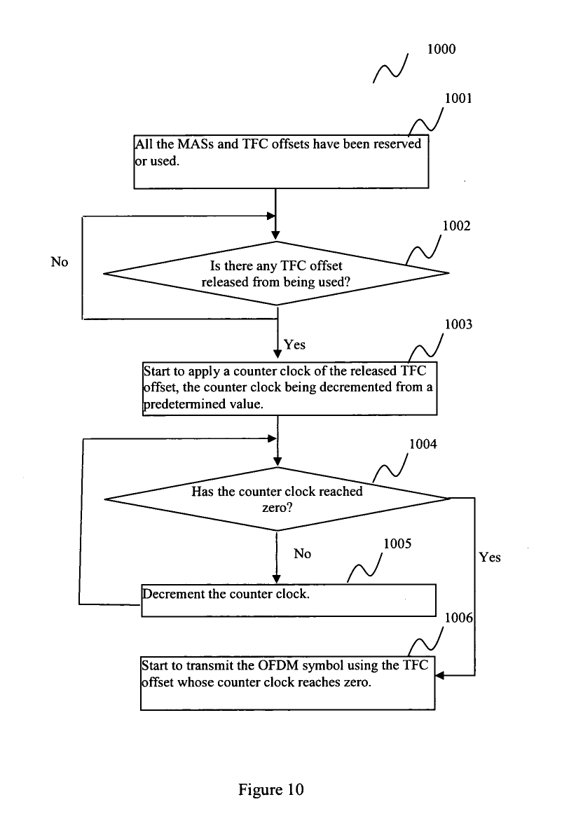

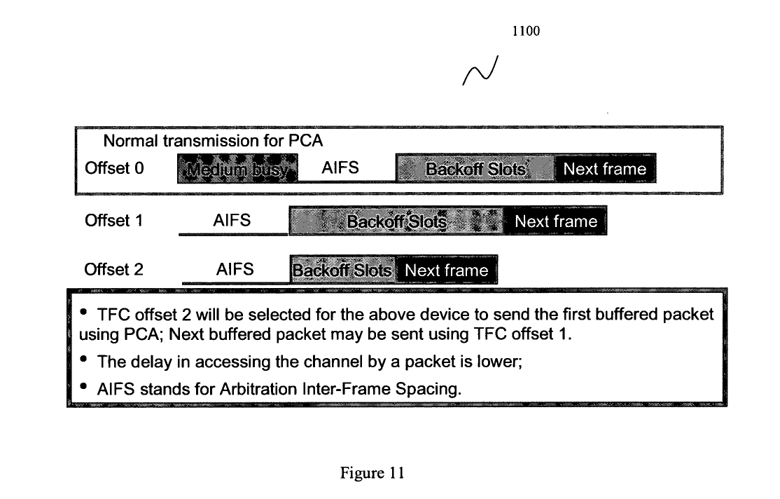

In one embodiment, the ad-hoc radio communication device for transmitting OFDM symbols within a ad-hoc radio communication group includes a selector configured to select a frequency sub-range of a frequency range for transmission in accordance with a frequency hopping pattern, the frequency range including a plurality of frequency sub-ranges, and a transmitter configured to transmit a OFDM symbol in the selected frequency sub-range in accordance with the frequency hopping pattern, wherein the selector selects the frequency sub-range of the frequency range for transmission such that the device transmits an OFDM symbol at a same transmission time period with another ad-hoc radio communication device that is within the same ad-hoc communication devices' group, wherein the other device uses a different frequency sub-range of the frequency range for transmission in accordance with a time shifte version of the frequency hopping pattern. In a further embodiment, the ad-hoc radio communication device further includes a synchronization circuit, wherein the synchronization circuit synchronizes the device with other devices within the ad-hoc radio communication devices' group. In a further embodiment, the ad-hoc radio communication device further comprises a counter clock applied to the frequency hopping pattern and to each time shifted version of the frequency hopping pattern, wherein upon the release of a frequency sub-range from being used in accordance with the frequency hopping pattern or a time shifted version of the frequency hopping pattern, the counter clock corresponding to the frequency hopping pattern or that time shifted version of the frequency hopping pattern starts being decremented from a predetermined value, and when the counter clock reaches zero, the device starts to transmit the OFDM symbol at the frequency sub-range in accordance with that frequency hopping pattern or that time shifted version of the frequency hopping pattern. The embodiments is illustrated in FIG. 5. As shown in FIG. 5, 500 represents the ad-hoc radio communication device, which includes a selector 501, a transmitter 502, a synchronization circuit 503, and a set of counter clocks 504. Further description of the counter clocks will be provide with respect to FIGS. 10 and 11.

In one embodiment, the ad-hoc radio communication device for transmitting OFDM symbols within an ad-hoc radio communication group includes a selector configured to select a first plurality of at least two frequency sub-ranges of a frequency range for transmission of a plurality of at least two OFDM symbols in accordance with a frequency hopping pattern, the frequency range comprising a plurality of frequency sub-ranges, and a transmitter configured to transmit the plurality of at least two OFDM symbols in the selected frequency sub-ranges in accordance with the frequency hopping pattern, wherein the selector is configured to select the plurality of the at least two frequency sub-ranges of the frequency range for transmission such that the device transmits the plurality of at least two OFDM symbols at a same transmission time period with another ad-hoc radio communication device that is within the same ad-hoc communication devices' group, wherein the other device uses a second plurality of at least two frequency sub-ranges of the frequency range for transmission of a plurality of at least two OFDM symbols in accordance with the same frequency hopping pattern or a different frequency hopping pattern, and wherein the first plurality of frequency sub-ranges has no overlap with the second plurality of frequency sub-ranges. In a further embodiment, the ad-hoc radio communication device further includes a synchronization circuit, wherein the synchronization circuit synchronizes the device with other devices within the ad-hoc radio communication devices' group. In a further embodiment, the ad-hoc radio communication device further comprises a counter clock applied to the frequency hopping pattern and to each time shifted version of the frequency hopping pattern, wherein upon the release of a frequency sub-range from being used in accordance with the frequency hopping pattern or a time shifted version of the frequency hopping pattern, the counter clock corresponding to the frequency hopping pattern or that time shifted version of the frequency hopping pattern starts being decremented from a predetermined value, and when the counter clock reaches zero, the device starts to transmit the OFDM symbol at the frequency sub-range in accordance with that frequency hopping pattern or that time shifted version of the frequency hopping pattern. The embodiments is also illustrated in FIG. 5. As shown in FIG. 5, 500 represents the ad-hoc radio communication device, which includes a selector 501, a transmitter 502, a synchronization circuit 503, and a set of counter clocks 504.

In order to facilitate transmission of OFDM symbols at exactly each OSTD, a synchronization method may be used using virtual clock concept to achieve finer synchronization between devices at nano-seconds level, so that OSTDs of devices are synchronized and do not overlap much to cause interference. The synchronization method proposed in [2] with a few suggested modifications will be described in more detail below.

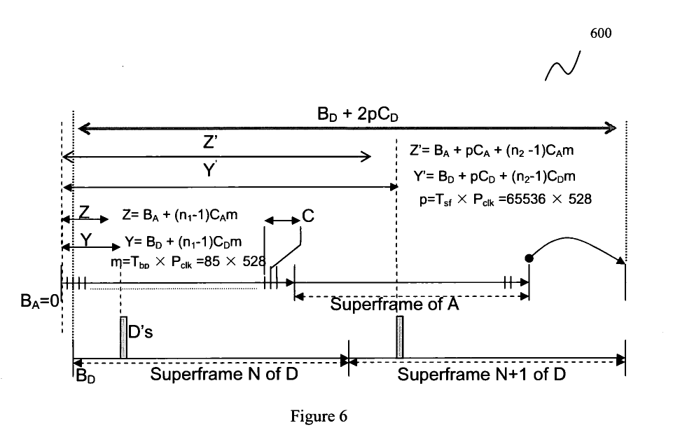

Refer to FIG. 1. Assume devices A 111 and D 114 (slower than A 111) have entered or joined a same beacon group. Let P_{clk} be the hardware clock (current ECMA PHY clock is 528 MHz). As shown in FIG. 6, let B_{A} be the BPST of device A 111, B_{D} be the BPST of device D 114 from A 111's perspective, C_{A} be the clock period of A 111 (Assume A 111's clock period to be 1/P_{clk}; assume A 111's clock to be of 528 MHz), and C_{D} be the clock period of D 114 from A 111's perspective. Let the beacon slot of D 114 as seen by A 111 be ‘n₁’, a known quantity. Let m=T_{bp}×P_{clk} be the number of clock cycles for a beacon slot duration, where T_{bp} is the time duration of each beacon slot. For current ECMA specified devices, T_{bp}=85 μs and P_{clk}=528 MHz. Hence m=85×528. In every beacon slot as seen by a device, the same device's physical clock counts m cycles. Let Y be the actual reception time of the beacon of D 114 at A 111 (discounting propagation time), Z be the estimated reception time of D 114's beacon at A 111.

Assume that no device moves its BPST at the end of the current (first) superframe (superframe N). In the next superframe (superframe N+1), the devices A 111 and D 114 do not move their BPST's. Let Y′ and Z′ be respectively the actual and estimated reception times of D 114's beacon at A 111 in superframe N+1. Let n₂ be the Beacon Slot Number of beacon of D 114 in superframe N+1. Let p=T_{sf}×P_{clk} be the number of clock cycles for a superframe duration, where T_{sf} is the time duration of one superframe. For current ECMA specified devices, T_{sf}=65536 μs, hence p=65536×528. In every superframe the same device's physical clock counts p cycles. Note that P_{clk} can be selected differently depending on individual implementations. For example, P_{clk} may also be selected based on 66 MHz clock. In such a case, m=85×66 and p=65536×66.

Now, Y, Z, Y′, and Z′ are known at device A with respect to a fixed reference time (could be the BPST of A 111, B_{A}). From the following four relations,

Z=B_{A}+(n₁−1)C_{A}m (1)

Y=B_{D}+(n₁−1)C_{D}m (2)

Z′=B_{A}+pC_{A}+(n₂−1)C_{A}m (3)

Y′=B_{D}+pC_{D}+(n₂−1)C_{D}m (4)

where m=T_{bp}×P_{clk}=85×528, p=T_{sf}×P_{clk}=65536×528

the estimates of B_{D} and C_{D} can be obtained in two superframes:

C_{D}=(Y′−Y)/(p+m(n₂−n₁)) (5)

B_{D}=Y−(n₁−1)C_{D}m=Y−(n₁−1)(Y′−Y)m/(p+m(n₂−n₁)) (6)

In the third superframe, the device A 111 may align its BPST to device D 114's BPST (which it knows through the knowledge of B_{D}+2pC_{D} and the fixed reference time) and reset its virtual clock count to zero. Let P_{A} be the number of physical clock cycles of A 111 during the superframe duration of D 114 (known to A 111) when P_{D} is the number of physical clock cycles of D 114 in that same superframe duration of D 114. It can be seen that P_{D}=p=65536×528.

If the device A 111 maintains a count of virtual clock cycles from the third superframe in such a way that its count of virtual clock cycles are obtained from the count of its physical clock cycles by subtracting one clock cycle from the count of its physical clock cycles every floor [P_{A}/(P_{A}−P_{D})] or Round [P_{A}/(P_{A}−P_{D})] of its physical clock cycles, the virtual clock of A 111 will be synchronized to the physical clock of D 114 to one clock period level.

In the above, the function floor [x] denotes the largest integer value not greater than the value ‘x’, and Round [x] denotes the nearest integer value to ‘x’.

If P_{A}−P_{D}=0, then the virtual clock is set to be the same as the physical clock. As seen above, only the first two superframes are needed for estimating clock periods and establishing the virtual clocks.

Two examples are given to illustrate the above proposed schemes.

### Example 1

Given n₁=n₂=n=5 and P_{clk}=528 MHz, C_{A}=1/528 μs, Y is measured as 342.595 μs and Y′ is measured as 65882.595. μs, then using equation (5), C_{D} can be estimated as 1.89405 ns and using equation (6), B_{D} can be estimated as 2.5752 μs. In the superframe duration of D 114 (=pC_{D}), A's clock counts, pC_{D}/C_{A}˜34605028 cycles. However, D 114's clock still counts p=65536×528=34603008 cycles. A 111's virtual clock is got from subtracting 1 clock cycle from every 17131 (which is =34605028/(34605028−34603008)) physical clock cycles of A 111.

### Example 2

Given n₁=n₂=n=5 and P_{clk}=66 MHz, C_{A}=1/66 μs, Y is measured as 342.595 μs and Y′ is measured as 65882.595 μs, then using equation (5), C_{D} can be estimated as 15.152 ns and using equation (6), B_{D} can be estimated as 2.584 μs. In the superframe duration of D 114(=pC_{D}), A 111's clock counts, pC_{D}/C_{A}˜4325514 cycles. However, D 114's clock still counts p=65536×66=4325376 cycles. A 111's virtual clock is got from subtracting 1 clock cycle from every 31344 (which is ˜4325514/(4325514−4325376)) physical clock cycles of A.

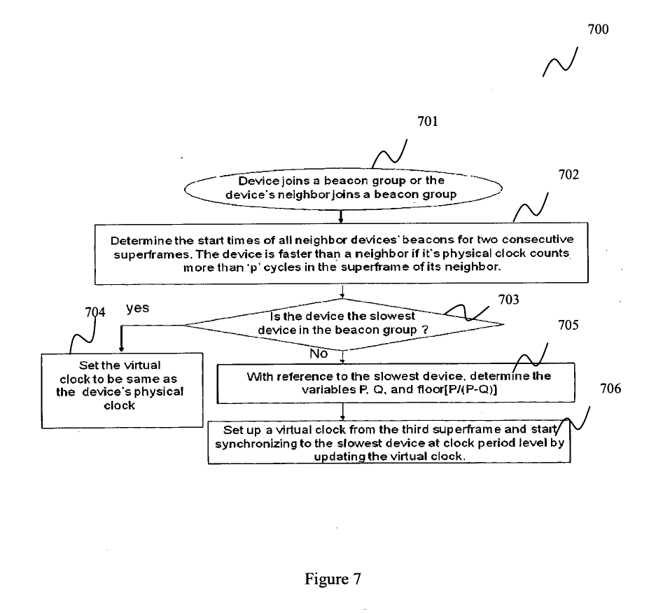

The flow diagram of the synchronization scheme is given in FIG. 7.

In FIG. 7, P is the number of physical clock cycles of a device during the duration of a superframe of slowest device, Q (Q=65536×528) is the number of physical clock cycles of the slowest device in the same duration of the superframe of slowest device. Firstly in process 701, a device joins a beacon group or the device's neighbor joins a beacon group. Then in process 702, the device determines the start times of all neighbor devices' beacons for two consecutive superframes. The device would be faster than a neighbor if its physical clock counts more than Q (=65536×528) cycles in the superframe of its neighbor. If the device determines that it is the slowest device in the beacon group, in process 704, the device sets the virtual clock to be same as the device's physical clock. If the device determines that it is not the slowest device in the beacon group, in process 705, the device determines the variables P, Q, and floor [P/(P−Q)] with reference to the slowest device. Following process 705, in process 706, the device sets up a virtual clock from the third superframe and stars synchronizing to the slowest device at clock period level by updating the virtual clock.

As mentioned above, the introduced synchronization method may achieve finer synchronization between devices at nano-seconds level, so that OSTDs of devices are synchronized and do not overlap much to cause interference.

In a further embodiment of the invention, when a device in the ad-hoc radio communication devices' group senses that a default frequency sub-range or a default TFC offset is not available for transmission of an OFDM symbol, the device may select another frequency sub-range or another TFC offset for transmission.

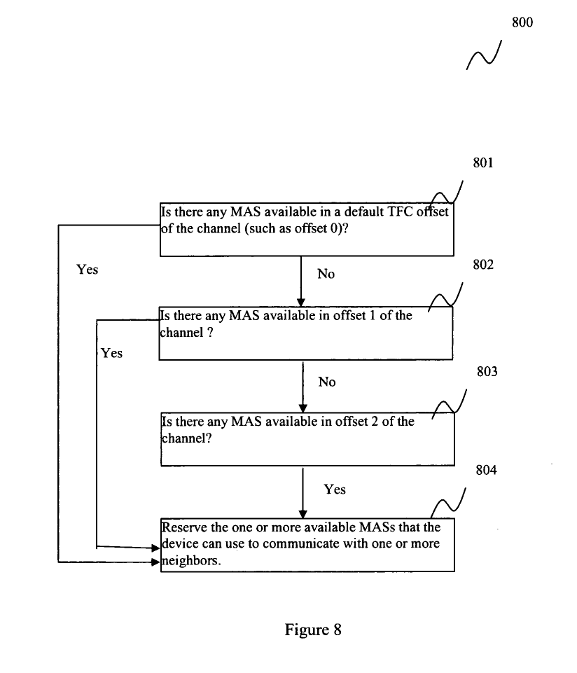

This embodiment is illustrated under the ECMA standard. The Distributed Reservation Protocol (DRP) is used in the ECMA standard. The DRP is a protocol implemented in each device to support negotiation and maintenance of channel time reservation binding on all neighbour devices of the reservation participants. The DRP enables devices to reserve one or more MASs that the device can use to communicate with one or more neighbours. According to an embodiment, a device always tries to search or reserve MASs where transmissions and receptions can happen using a default TFC offset (TFC offset 0) for transmission in accordance with a frequency hopping pattern. If adequate bandwidth is not available, then the device may try to reserve MAS slots for transmissions and reception using the next higher TFC offset of the channel for transmission in accordance with a time shifted version of the frequency hopping pattern of the default TFC offset. For example, a device always reserves MASs pertaining to TFC offset 0 as shown in FIG. 2, when it requires bandwidth. If all the MASs are reserved for TFC offset 0, then the device may try to reserve MASs for higher TFC offsets of the channel such as TFC offset 1 or TFC offset 2 as shown in FIG. 2 in the same band group. The device should ensure that all the MASs are occupied for the default TFC offset (TFC offset 0) before reserving MASs for another TFC offset such as TFC offset 1 or TFC offset 2. This embodiment is illustrated in FIG. 8. Firstly in process 801, a device determines whether there is any MAS available in a default TFC offset (such as TFC offset 0) starting at a default frequency sub-range (such as frequency band 211 in FIG. 2). If yes, in process 804, the device reserves the one or more available MASs in the default TFC offset that the device can use to communicate with one or more neighbors. If no, the device proceeds to process 802, and determines whether there is any available MAS in next higher TFC offset of the channel (such as TFC offset 1) starting at another frequency sub-range (such as frequency band 221 in FIG. 2). If yes, in process 804, the device reserves the one or more available MASs that the device can use to communicate with one or more neighbors. If no, the device proceeds to process 803, and determines whether there is any available MAS in next higher TFC offset of the channel (such as TFC offset 2) starting at another frequency sub-range (such as frequency band 231 in FIG. 2). If yes, in process 804, the device reserves the one or more available MASs that the device can use to communicate with one or more neighbors.

Alternatively, in another embodiment, a device in the ad-hoc radio communication device group selects or reserves a frequency sub-range in accordance with a time shifted version of the frequency hopping pattern, the frequency sub-range being different from a frequency sub-range that has been reserved or selected by another device in accordance with the frequency hopping pattern or a time shifted version of the frequency hopping pattern in the ad-hoc radio communication devices' group. When a device in the ad-hoc radio communication devices' group senses that during a time period, a frequency sub-range of the frequency range or a TFC offset for transmission in accordance with the frequency hopping pattern is reserved or occupied, the device selects a different frequency sub-range from the frequency range or a higher TFC offset that has not been selected or occupied for transmission of OFDM symbols. This embodiment is also illustrated under the ECMA standard.

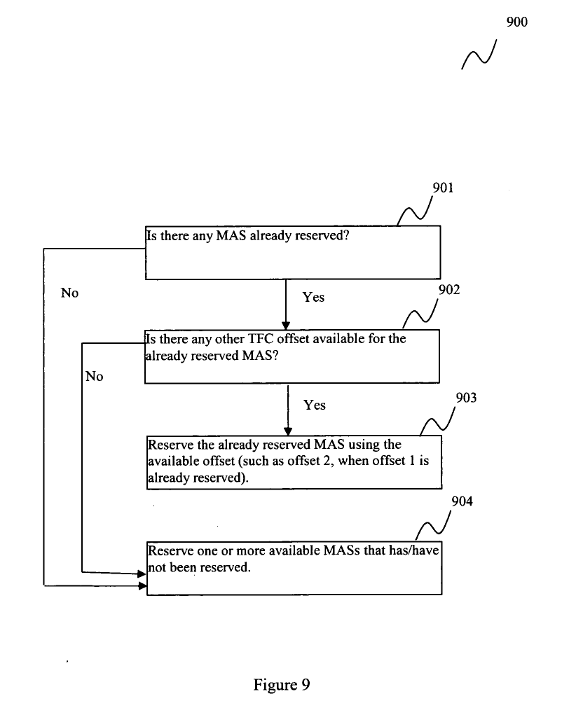

For example, a device seeking reservation of bandwidth always tries to reserve or use the already reserved time slots (MASs) by using an unused TFC offset of the channel. If the reserved MASs are unavailable for the device for any TFC offset of the channel, then the device seeks to reserve MASs other than the ones already reserved. This embodiment is further illustrated in FIG. 9. In process. 901, a device determines whether there is any MAS that has already been selected or reserved. If no, the device proceeds to process 904, and reserves one or more available MASs that has/have not been reserved or selected. If yes, the device proceeds to process 902, and determines whether there is any other TFC offset available for the already reserved MAS. If no, the device proceeds to process 904, and reserves one or more available MASs that has/have not been reserved or selected. If yes, the device proceeds to process 903, and reserves the already reserved MAS using the available TFC offset of the channel (such as TFC offset 1, when TFC offset 0 is reserved).

In one embodiment, if a device that wants to transmit an OFDM symbol in the ad-hoc radio communication devices' group senses that all the frequency sub-ranges of a frequency range for transmission in accordance with a frequency hopping pattern and all the time shifted versions of the frequency hopping pattern are already reserved or used, the device will select a frequency sub-range in accordance with the frequency hopping pattern or a time shifted version of the frequency hopping pattern for transmission that will be first released from being used to transmit the OFDM symbol in accordance with the frequency hopping pattern or the time shifted version of the frequency hopping pattern. In a further embodiment, a counter clock is applied for the frequency hopping pattern or to each of the time shifted version of the frequency hopping pattern, wherein upon the release of a frequency sub-range from being used in accordance with the frequency hopping pattern or a time shifted version of the frequency hopping pattern, the counter clock corresponding to the frequency hopping pattern or that time shifted version of the frequency hopping pattern starts being decremented from a predetermined value, and when the counter clock reaches zero, the device starts to transmit the OFDM symbol at the frequency sub-range in accordance with the frequency hopping pattern or the time shifted version of the frequency hopping pattern.

The embodiment is also illustrated in the ECMA standard. Prioritized Channel Access (PCA) is used in the ECMA standard to provide differentiated distributed contention access to the medium for a device for transmission. As an illustration of the embodiment, three independent and parallel implementations of the existing PCA back off module and protocol (as specified by the ECMA specification) are proposed to be used in parallel for use of the TFC offsets with different starting frequency sub-ranges using PCA.

For example, when a device has a data packet to send using the PCA, the device tries to send the packet using the default TFC offset (TFC offset 0) as shown in FIG. 2 in a MAS. When a device senses the TFC offset 0 of the channel busy, the device invokes a back off mechanism similar to that used by the PCA in the ECMA specification. The back off counter is frozen as long as the TFC offset 0 remains in use or busy, and the back off counter is decremented when the TFC offset 0 of the channel is sensed idle. In one embodiment, the use of one back off counter is provided for each TFC offset of the channel (three independent modules each similar to that used by PCA in the ECMA specification; see FIG. 11). When a device has packet to send and senses all the TFC offsets of the channel busy, the device invokes a back off mechanism similar to that used by the PCA in the ECMA specification. The back off counter for a TFC offset is frozen as long as the TFC offset remains in use or busy, and the back off counter is decremented when the TFC offset of the channel is sensed idle. When any of the three back off counters reaches zero, the packet is transmitted using the TFC offset corresponding to the back off counter that reached zero. Hence, the packet is transmitted as soon as one of the back off counters corresponding to the three TFC offsets of the channel reaches zero. As a side note, the delay in accessing one of the TFC offsets by a packet is lower as compared to the case when only a default channel (with no TFC offsets) is used. Optionally, every TFC offset can also cater to multiple Access Categories (ACs) as specified in the ECMA standard. The Arbitration Inter-Frame Spacing (AIFS) and the maximum back off counter value may be different for different Access Categories for each TFC offset.

This embodiment is further illustrated in FIG. 10. In process 1001, assume that all the MASs and TFC offsets of the channel have been reserved or used. Following process 1001, the device determines whether there is any TFC offset (with a starting frequency sub-range of the frequency range for transmission in accordance with a frequency hopping pattern) released from being used in process 1002. If no, the device keeps to repeat the determination carried out in process 1002. If yes, the device proceeds to process 1003, and applies a counter clock of the released TFC offset of the channel, the counter clock being decremented from a predetermined value. Then in process 1004, the device determines whether the counter clock has reached zero. If no, the device further decrements the counter clock in process 1005, and proceeds to process 1004. If yes, the device starts to transmit the OFDM symbol using the TFC offset of the channel whose counter clock reaches zero in process 1006.

It should be noted that the device may be equipped with a counter clock for each TFC offset for every AC, and the device may start to transmit an OFDM symbol for an AC using a TFC offset whose counter clock first reaches zero. This embodiment is also illustrated in FIG. 11, wherein the device is equipped with a counter clock for each TFC offset of the channel (TFC offset 0, TFC offset 1, and TFC offset 2). As can be seen in FIG. 11, after the ‘Medium busy’ state, there is an Arbitration Inter-Frame Spacing (AIFS) period before a counter clock is applied. For each TFC offset of the channel, there is a corresponding counter clock. In the illustration of FIG. 11, the counter clock of TFC offset 2 first reaches zero. Thus, TFC offset 2 will be selected by the device to transmit an OFDM symbol of a first buffered packet. It can also be seen that the counter clock corresponding to TFC offset 1 secondly reaches zero. Thus, the device will use TFC offset 1 for the transmission of OFDM symbol of next buffered packet. This embodiment has the advantage that the delay in accessing the channel (any TFC offset) by a data packet is lower.

When a device boots up in an ad-hoc radio communication group, it may look for neighbors by scanning the TFCs (channels). A TFC offset of a channel such as TFC offset 0 shown in FIG. 2 may be considered as a default TFC offset of the channel for beacon transmission. Alternatively, the device may select a random or any fixed TFC offset of the channel for transmitting OFDM symbols of beacons. In one embodiment, it is proposed that every device that sends a beacon be required to include the PHY Capabilities and the MAC Capabilities Information Elements (IEs). In the following, additions and modifications of the IEs in the ECMA standard are proposed in accordance with various embodiments.

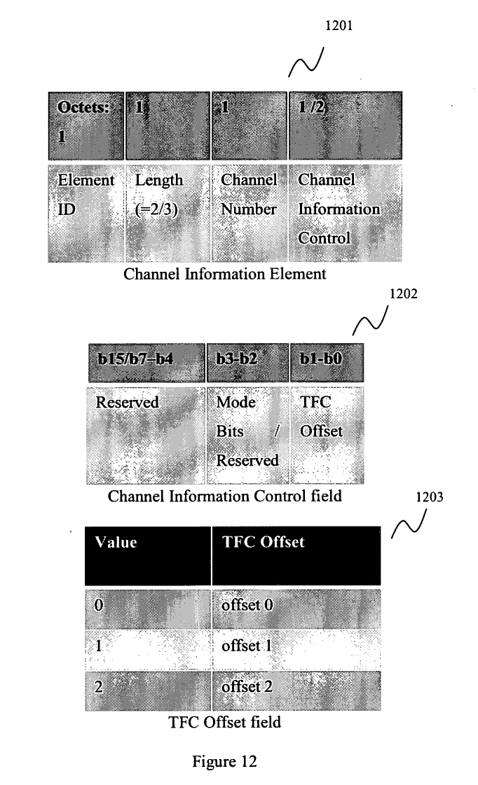

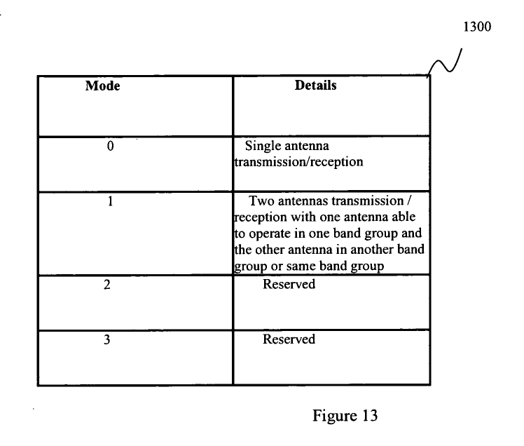

Channel IE: The format of the Channel IE is shown in FIG. 12, table 1201. The Channel Information Control field is further illustrated in table 1202, and the TFC Offset field in table 1202 is further illustrated in table 1203. The Channel Number is as specified in WiMedia PHY standard. If a beacon is sent in a randomly or any fixed chosen TFC offset of the channel, for example, either TFC offset 0, or TFC offset 1, or TFC offset 2 as shown in FIG. 2, the device sending the beacon shall also include the new Channel IE in its beacon. In one embodiment, the frequency channel may or may not be different from the channel the ad-hoc radio communication device uses to send beacons. The TFC Offset bits in table 1202 are used to inform the TFC offset of the channel and the Mode Bits in table 1202 are inferred as shown in FIG. 13.

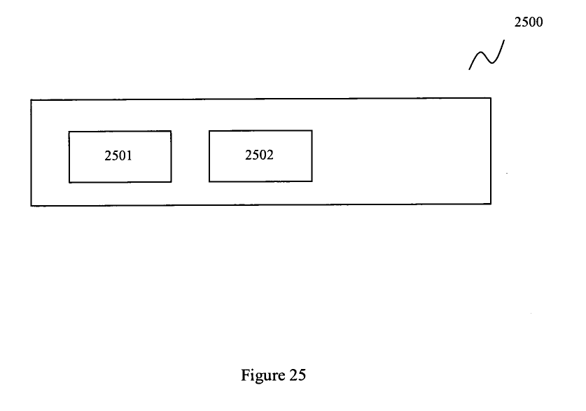

In one embodiment, an ad-hoc radio communication device within an ad-hoc radio communication devices' group for transmitting OFDM symbols comprises a generating unit configured to generate a channel information message including information about frequency channel number the ad-hoc radio communication device uses to send beacons; and a transmitting unit configured to transmit the channel information message to at least one other ad-hoc radio communication device with which the ad-hoc radio communication device has an established communication connection in a current frequency channel. This embodiment is illustrated in FIG. 25, wherein an ad-hoc radio communication device 2500 comprises a generating unit 2501 and a transmitting unit 2502.

In one embodiment, the channel information message further comprises information on a frequency hopping pattern or a time shifted version of that frequency hopping pattern that the device uses to send beacons, wherein the frequency hopping pattern is with reference to a fixed point of time.

In one embodiment, the channel information message further comprises information on number of antennas being used by the device for a fixed period of time.

In one embodiment, the fixed period of time is a superframe and the fixed point of time is the start of a beacon slot or the start of a Medium Access Slot.

To cater to the proposed method for OFDM transmission, some changes are required in a few Information Elements (IEs) as specified in the current ECMA specification as follows:

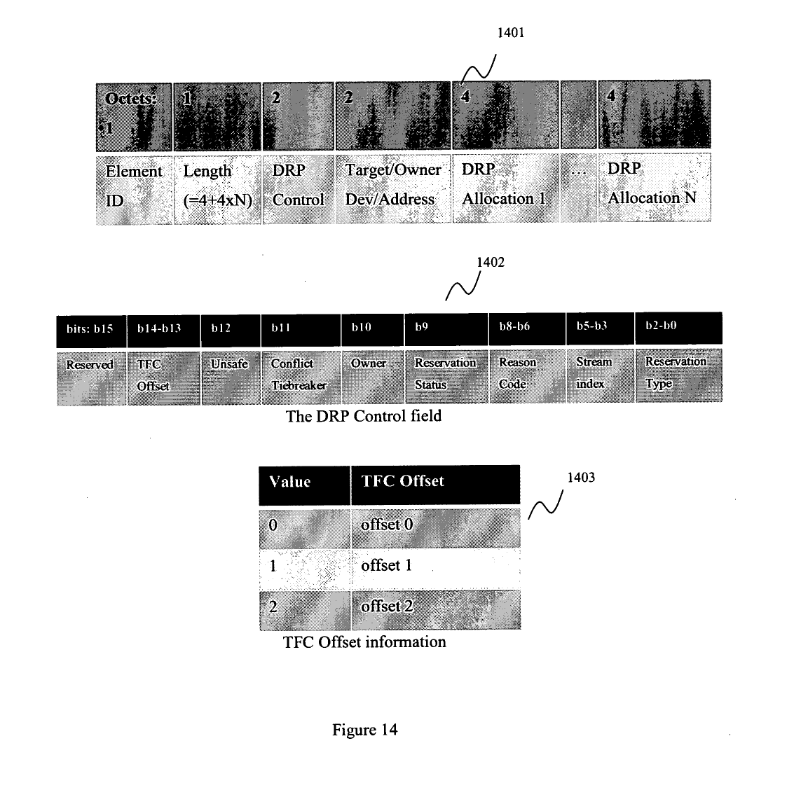

DRP IE: Bits b13 and b14 that are currently reserved in the DRP Control field are proposed in the DRP IE to indicate the TFC offset of the channel as shown in FIG. 14. Table 1401 illustrates the DRP IE. Table 1402 shows the DRP control field of table 1401. Table 1403 shows bits b13 and b14 of the DRP Control field, which are used to indicate the TFC offset of the channel.

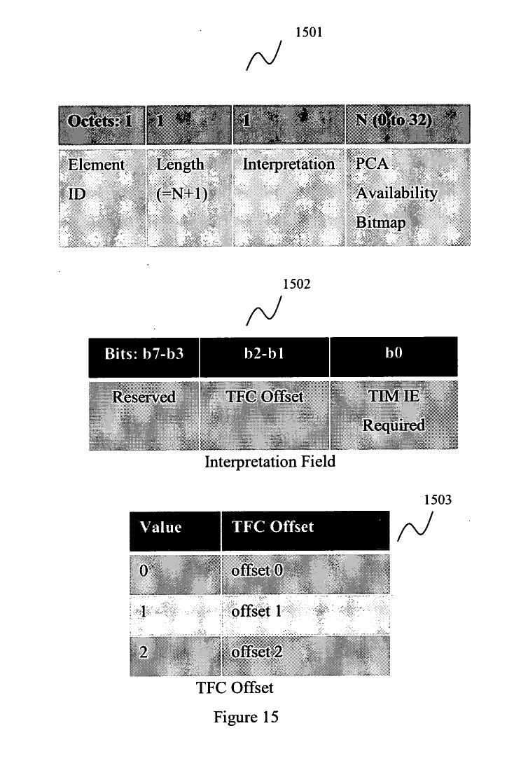

PCA Availability IE: The two reserved bits (b2-b1) of the Interpretation field of the PCA Availability IE are proposed to indicate the TFC offset of the channel. As shown in FIG. 15, additional PCA Availability IEs are proposed to be sent if PCA availability for an additional TFC offset of the channel is required. Table 1501 shows the PCA Availability IE. Table 1502 shows the Interpretation field of table 1501. Table 1503 shows the use of two reserved bits b2-b1 of table 1502, which are used to indicate the TFC offset of channel.

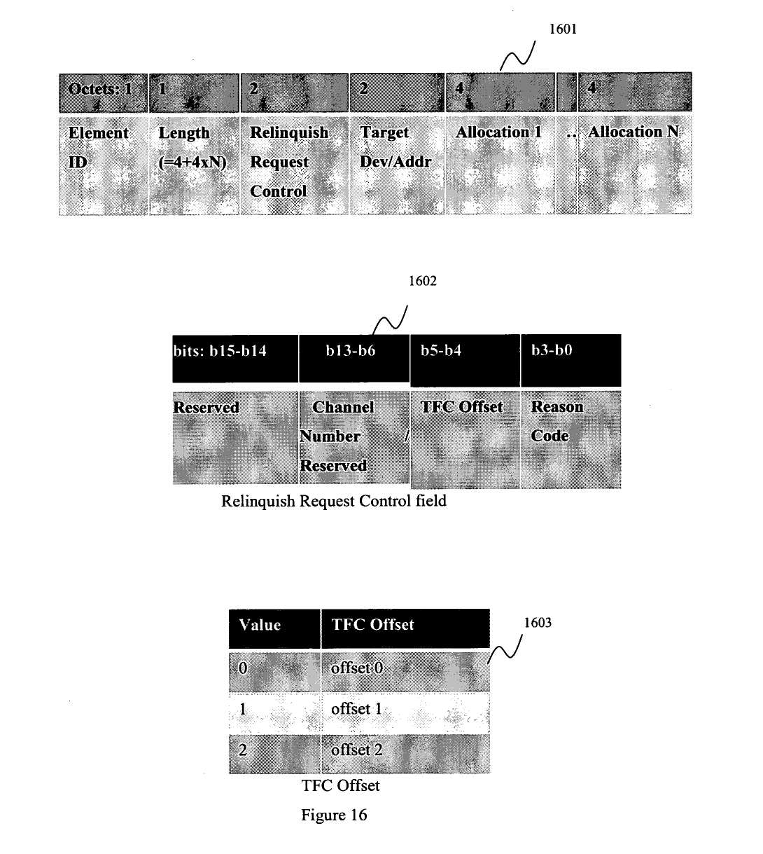

Relinquish Request IE: Two reserved bits (b5-b4) of the Relinquish Request IE are proposed to indicate the TFC offset of the channel. Additional eight of the reserved bits (b13-b6) are proposed to indicate Channel Number as shown in FIG. 16. Table 1601 shows the Relinquish Request IE. Table 1602 shows the Relinquish Request Control field of table 1601 in more detail. Table 1603 shows the reserved bits b5-b4 of table 1602, which are used to indicate the TFC offset of the channel.

MAC Capabilities IE: One of the reserved bits in the current MAC Capabilities IE as given in the ECMA standard is proposed to be used to indicate the capability of the device to transmit in TFC offsets of the channel, and another reserved bit is proposed to be used to indicate if the device is able to transmit and receive using alternate channels.

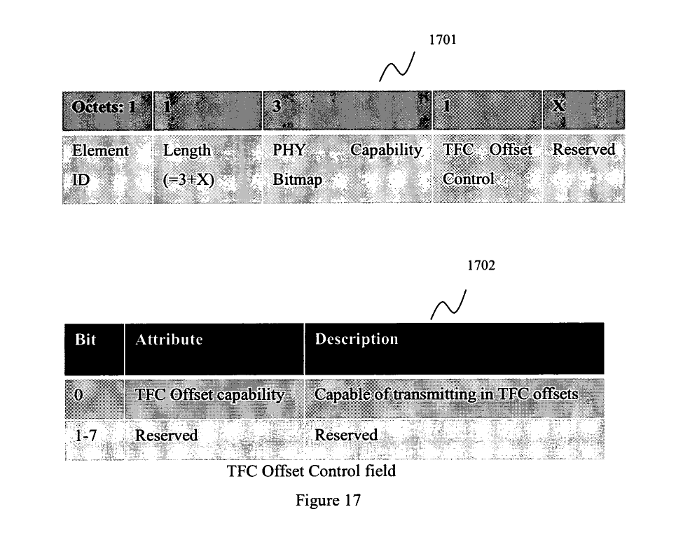

PHY Capabilities IE: One of the reserved octets are proposed to be used for TFC Offset Control. In this TFC Offset Control field, one of the bits is used to indicate the capability of a device to transmit in TFC offsets of the channel as shown in FIG. 17. Table 1701 shows TFC Offset Control field in the IE. Table 1702 shows the TFC Offset Control field of table 1701 in more detail.

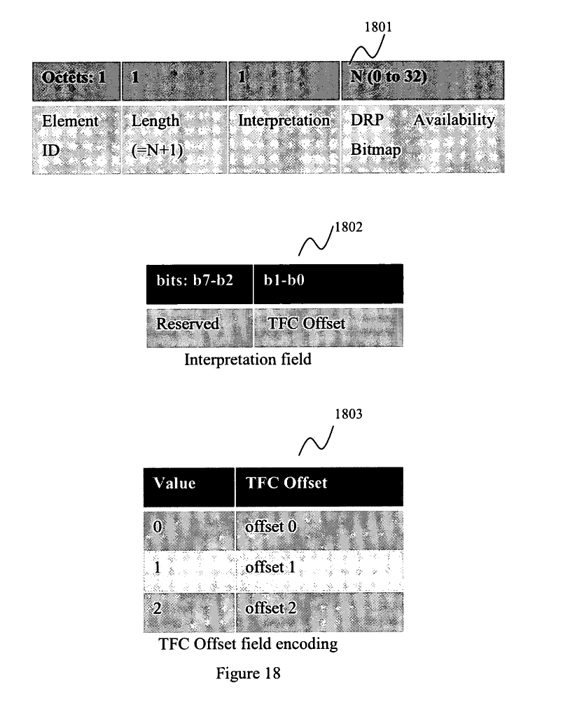

Enhanced DRP Availability IE: A new IE is proposed to be added to indicate a device's view of the current utilization of MASs in the current superframe (catering to the use of TFC offsets of the channel) as shown in FIG. 18. Table 1801 shows the newly proposed IE. Table 1802 shows the Interpretation field of table 1801 in more detail. Table 1803 shows bit1-bit0 of the Interpretation field of table 1802 in more detail.

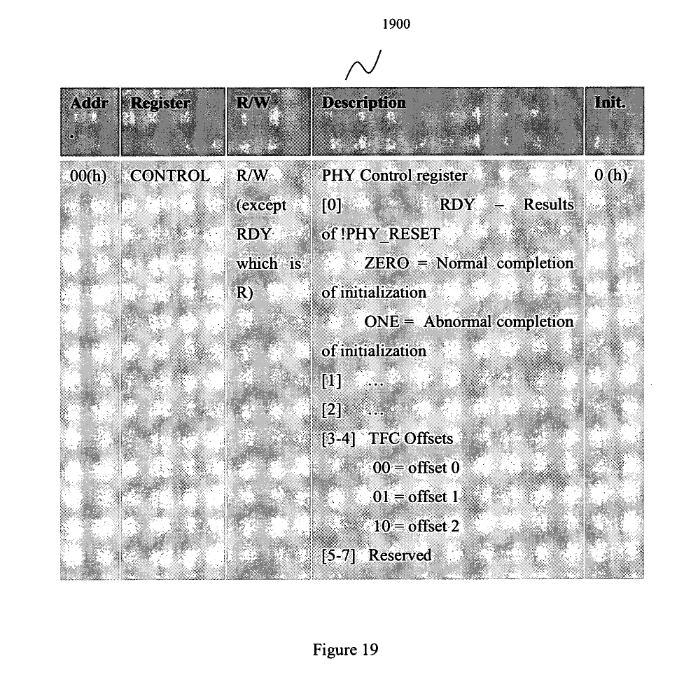

Dynamic Registers: Two of the reserved bits of PHY Control register as in current ECMA specification are proposed to be used for TFC Offset Control as shown in FIG. 19.

In one embodiment, the ad-hoc radio communication devices in an ad-hoc radio communication devices' group are not synchronized. In such a case, a device in the group may listen to the medium through one of the available antennas to transmit a signal in a unused frequency band through the other antenna. The operation may not be synchronized among devices.

As a further illustration of the method for transmitting OFDM symbols under the ECMA standard according to an embodiment of the invention, transmission of OFDM symbols may also be operated among different band groups.

In one embodiment, the method for transmitting OFDM symbols by a plurality of ad-hoc radio communication devices in an ad-hoc radio communication devices' group comprises a first ad-hoc radio communication device of the ad-hoc radio communication devices' group transmitting a first OFDM symbol in a first frequency sub-range of a first frequency range selected for transmission in accordance with a frequency hopping pattern, the first frequency range comprising a plurality of frequency sub-ranges; in the same or overlapping transmission time period, a second ad-hoc radio communication device of the ad-hoc radio communication devices' group transmitting a second OFDM symbol in a second frequency sub-range of a second frequency range, in accordance with a different frequency hopping pattern, wherein the second frequency range is different from the first frequency range.

In one embodiment of the invention, the method for transmitting OFDM symbols by an ad-hoc radio communication device in an ad-hoc radio communication devices' group in a fixed time period comprises the ad-hoc radio communication device of the ad-hoc radio communication devices' group transmitting OFDM symbols in a first frequency range selected for transmission in accordance with a frequency hopping pattern in a first sub-period within the fixed time period, the first frequency range comprising a plurality of frequency sub-ranges; in a second sub-period different from the first sub-period within the above same fixed time period the ad-hoc radio communication device of the ad-hoc radio communication devices' group transmitting OFDM symbols in a second frequency range, in accordance with a different frequency hopping pattern, wherein the second frequency range is different from the first frequency range.

In one embodiment, an ad-hoc radio communication device within an ad-hoc radio communication devices' group for transmitting OFDM symbols comprises a transmitter configured to transmit OFDM symbols in a first frequency range selected for transmission in accordance with a frequency hopping pattern in a first sub-period within a fixed time period, the first frequency range comprising a plurality of frequency sub-ranges, the transmitter also being configured to, in a second sub-period different from the first sub-period within the above same fixed time period, transmit OFDM symbols in a second frequency range, in accordance with a different frequency hopping pattern, wherein the second frequency range is different from the first frequency range. This embodiment is illustrated in FIG. 25. In FIG. 25, the ad-hoc radio communication device 2500 comprises a transmitter 2501.

In one embodiment, an ad-hoc radio communication device within an ad-hoc radio communication devices' group for transmitting OFDM symbols comprises: a transmitter to transmit OFDM symbols to other devices of the ad-hoc radio communication devices' group; a receiver to receive OFDM symbols from other devices of the ad-hoc radio communication devices' group, wherein the transmitter is configured to transmit a first OFDM symbol in a first frequency sub-range of a first frequency range selected for transmission in accordance with a frequency hopping pattern in the same or overlapping transmission time period when a transmitter of a second ad-hoc radio communication device of the ad-hoc radio communication devices' group transmits a second OFDM symbol in a second frequency sub-range of a second frequency range, in accordance with a different frequency hopping pattern, wherein the first frequency range comprises a plurality of frequency sub-ranges, and the second frequency range is different from the first frequency range. This embodiment is illustrated in FIG. 25: the ad-hoc radio communication device 2500 comprises a transmitter 2501 and a receiver 2502.

For example, any two ad-hoc communication devices in an ad-hoc communication devices' group may communicate in a different band group using an alternate channel (channel other than the one in which normal beacons as given in ECMA standard are sent) using the Prioritized Contention Access (PCA) or the Distributed Reservation Protocol (DRP) during certain MASs in a superframe. In this regard, normal beacon refers to the beacon that is sent within the frequency channel (default channel) that all the ad-hoc radio communication devices within the ad-hoc radio communication devices' group are operating in. In this case, all the devices send the beacons only in one band group in a default channel that they are operating in. According to the embodiment of the invention, devices can communicate in an alternate channel in another band group other than the channel in which normal beacons were sent in accordance with a different frequency hopping pattern, using both the DRP and the PCA during the data period of the superframe. However, the devices need to revert to the default channel for their beacon transmissions in their beacon period.

Moreover, a device may invite a sub beacon group (sub ad-hoc radio communication devices' group) to join itself in another channel (alternate channel) of another band group for certain number of MASs during the data period of the superframe to communicate using the PCA or the DRP. Referring to FIG. 1, assume that a DRP reservation arrangement is made between two devices A 111 and B 112. According to an embodiment, devices C 113 and D 114 can have simultaneous time reservation in another band group in an alternate channel, and devices E 115 and F 116 similarly can have a simultaneous time reservation in a third band group in another alternate channel. It can be clearly seen that the throughput of the network can be increased.

In this case, every device needs to scan the alternate channel of another band group that it intends to use for availability at least for one superframe to ensure that the alternate channel is available. As an example, if a device discovers another beacon group (ad-hoc radio communication devices' group) in an alternate channel, the device may not use that channel (alternate channel) for communicating with other devices in its beacon group either using the PCA or the DRP. The device shall also periodically reinitiate the scan every fixed number of superframes for a superframe duration to ensure that no new beacon group has been started in the alternate channel and that if the channel is available for alternate channel use. A device that envisages itself scanning an alternate channel in a superframe may advertise itself as unavailable for the PCA or the DRP in the alternate channel (or also in the default channel) during that superframe.

Further, every device that sends frames in an alternate channel during certain MASs in the data period of the superframe, shall send an alternate channel beacon frame (a beacon frame with one of the reserved bits in its device control field set to one to inform that it is an alternate channel beacon) at least once during the data period of the superframe of the device. This will allow any device scanning any channel to know that there is indeed an alternate channel usage in that channel upon reception of such an alternate channel beacon. Any entering device that hears an alternate channel beacon is not required to align its BPST to the BPST indicated by the alternate channel beacon. Moreover, the entering device is also allowed to start its own beacon group if there is no existing normal beacons in that channel. In the meantime, the devices that use the channel as an alternate channel shall vacate the channel in the next fixed number of superframes upon discovery of normal beacons in that channel (used as alternate channel).

Alternatively, in another embodiment every device that intends to send or receive frames in an alternate channel during certain MASs in the data period of the superframe, shall send an alternate channel beacon frame (a beacon frame with one of the reserved bits in its device control field set to one to inform that it is an alternate channel beacon) in a discovered beacon period in the alternate channel. If no beacon period is discovered in the alternate channel, the device may choose its own BPST for the alternate channel beacon. A device shall maintain one and only one primary (default) channel following the rules given in ECMA standard. However, a device is also allowed to join or form beacon groups in multiple alternate channels using alternate channel beacons. Alternate channel beacons are suggested to differentiate the primary (default) channel usage from alternate channel usage. Any entering device (a device that powers up) that hears an alternate channel beacon is required to align its BPST to the BPST indicated by the alternate channel beacon if it intends to use the channel. However, the entering device shall send normal beacons (because it is required to have one primary channel).

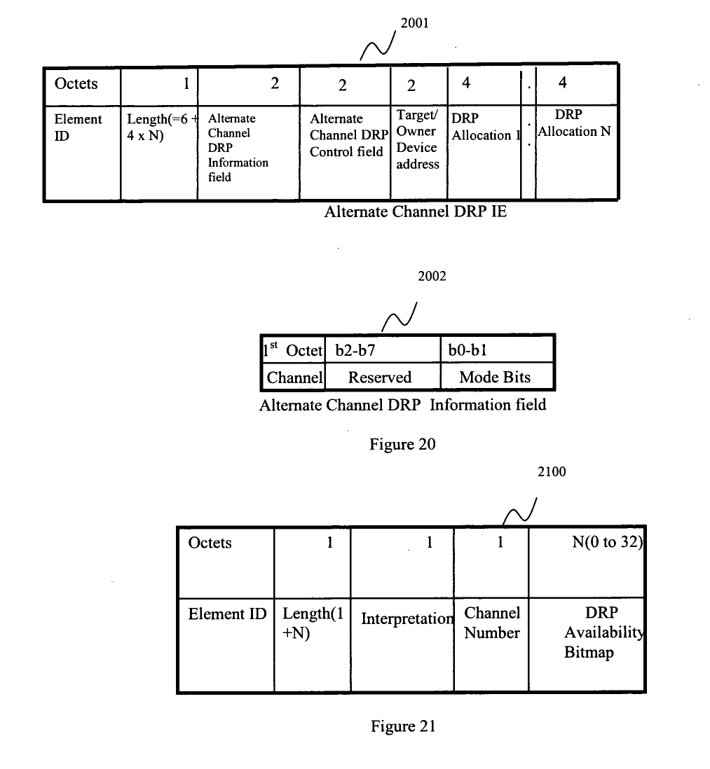

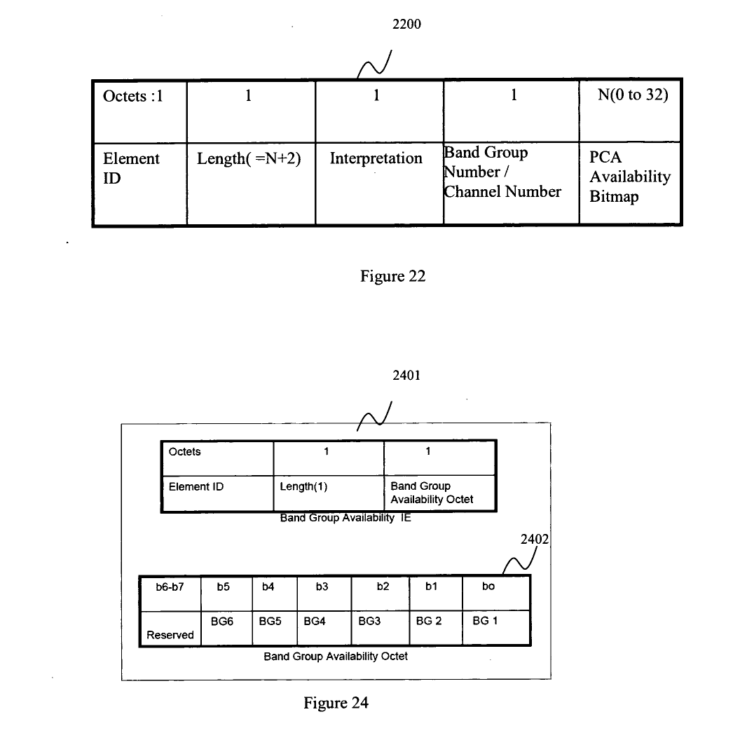

In a further embodiment, the devices that use the channel as an alternate channel may continue to use the channel as alternate channel upon discovery of normal beacons in that alternate channel's BP. However, in reservation of bandwidth, priority of usage of channel is given to a device that sends normal beacons. In any conflict resolution protocol of DRP, a device sending normal beacons gets the priority over a device that sends alternate channel beacons. If there is conflict between two devices both using normal beacons or both using alternate channel beacons, then the conflict resolution is as given in ECMA standard. For reservation of bandwidth in alternate channel, the device may negotiate for MAS usage with a neighbor that uses or intends to use the same alternate Channel using the IEs proposed in this description (including Alternate Channel DRP IE, Alternate Channel DRP Availability IE, and Alternate Channel PCA Availability IE; see e.g. FIG. 20, FIG. 21, and FIG. 22) using the primary (default) channel. Once reservation is negotiated, the reservation has to be announced using DRP IEs in the alternate channel beacons in the alternate channel. Alternatively, two devices can negotiate for reservation using DRP IEs using the alternate channel (with alternate channel beacons). In this case the DRP negotiation takes place in the alternate channel and not in the primary channel.

In a further embodiment, for a device to start or join a beacon group in an alternate channel, the device is not required to go in to hibernation in the primary (default) channel. As side information, devices in hibernation mode do not transmit beacons or frames. The alternate channel beacon may be sent by the device in the alternate channel during the data period in the superframe of the primary channel. However, the device shall be available to hear beacons during the BP in the alternate channel. Other devices from any beacon group from any primary (default) channel are allowed to form a beacon group with a device sending an alternate channel beacon in an alternate channel by they themselves sending alternate channel beacons and aligning their BPSTs in the alternate channel to that of the received alternate channel beacon.

In a further embodiment, every device needs to scan the alternate channel that it intends to use for a fixed, say mAlternateChannelScan superframes. If a device discovers normal or alternate channel beacons it may join the beacon group by sending alternate channel beacons. The device may also announce Hibernation for mAlternateChannelScan superframes in the primary channel when the device scans the alternate channel. Any device that envisages itself scanning an alternate channel in a superframe may advertise itself as unavailable for PCA or DRP in the primary or default channel during that superframe. Any device that sends an alternate channel beacon may optionally also include a new IE called the Channel IE (see FIG. 12) described in this description. This would allow any device hearing an alternate channel beacon to determine the primary channel of the device sending the beacon. A device hearing an alternate channel beacon can also find out (using the combination of channel IE and the device identifier field in the alternate channel beacon) if any of the devices in its own extended beacon group is using that alternate channel. As side information, the extended beacon group refers to union of a device's beacon group and the beacon groups of all the devices in the device's beacon group.

It should be noted that although the illustration is made based on the ECMA standard, the embodiment of the invention is not limited to the ECMA standard, but can be extended to any multi band system.

In contrast, as mentioned earlier, in the current version of the ECMA standard, when a DRP reservation arrangement is made between devices A 111 and B 112 (FIG. 1), the other devices in the beacon group of node B have to remain silent during the corresponding Medium Access Slots (MASs) used for the DRP. Note that all the devices are assumed to be using a particular band group and a particular TFC or channel. The result is that the other band groups (constituting 11 bands and many channels) remain unutilized.

To cater to the proposed multi band group based MAC scheme, some new information elements (IEs) are proposed as follows:

Alternate Channel DRP IE: The format of the Alternate Channel DRP IE is shown in FIG. 20. The Alternate Channel DRP Control field takes the same format as given for DRP Control field shown in FIG. 14. The TFC Offset bits are used to indicate the TFC offset of the channel (given by the reserved bits in the DRP Control field as proposed earlier). Mode Bits (given above in FIG. 13) are included as two bits proposed herein as part of the Alternate Channel DRP Information field. Table 2001 shows the Alternate Channel DRP IE. Table 2002 shows the Alternate Channel DRP Information field of table 2001 in more detail. In one embodiment, two of the reserved bits in table 2002 may be used for indicating TFC Offset (given in FIG. 12).

In one embodiment, an ad-hoc radio communication device within an ad-hoc radio communication devices' group for transmitting OFDM symbols comprises a generating unit configured to generate a reservation negotiation message including information about time slots the ad-hoc radio communication device is negotiation reservation for; and a transmitting unit configured to transmit the reservation negotiation message to at least one other ad-hoc radio communication device with which the ad-hoc radio communication device has an established communication connection in a current frequency channel. This embodiment is illustrated in FIG. 25, wherein an ad-hoc radio communication device within an ad-hoc radio communication devices' group comprises a generating unit 2501 and a transmitting unit 2502.

In one embodiment, the reservation negotiation message further comprises information on a frequency hopping pattern or a time shifted version of that frequency hopping pattern that the device wishes to seek reservation in for the particular time slots, wherein the frequency hopping pattern may be with reference to a fixed point of time which may be the start of a Medium Access Slot.

In one embodiment, the reservation negotiation message further comprises information on frequency channel number in which the reservation for the time slots is sought.

In one embodiment, the reservation negotiation message further comprises information on the number of antennas and the type of transmission proposed to be used in the time slots for which reservation is sought.

Alternate Channel DRP Availability IE: The format of the Alternate Channel DRP Availability IE is given in FIG. 21. The DRP Availability Bitmap is as used in the DRP Availability IE in the ECMA standard. The interpretation field is as proposed earlier for the Enhanced DRP Availability IE (FIG. 18).

In one embodiment, an ad-hoc radio communication device within an ad-hoc radio communication devices' group for transmitting OFDM symbols comprises a generating unit configured to generate a reservation availability advertisement message including information about time slots where the ad-hoc radio communication device knows further reservations are possible; and a transmitting unit configured to transmit the reservation availability advertisement message to at least one other ad-hoc radio communication device with which the ad-hoc radio communication device has an established communication connection in a current frequency channel. This embodiment is illustrated in FIG. 25, wherein an ad-hoc radio communication device within an ad-hoc radio communication devices' group comprises a generating unit 2501 and a transmitting unit 2502.

In one embodiment, the reservation availability advertisement message further comprises information on a frequency hopping pattern or a time shifted version of that frequency hopping pattern for which the device advertises reservation availability or availability of time slots for reservation, wherein the frequency hopping pattern may be with reference to a fixed point of time which may be the start of a Medium Access Slot.

In one embodiment, the reservation availability advertisement message further comprises information on frequency channel number concerning which the reservation availability or availability of time slots is advertised.

Alternate Channel PCA Availability IE: The format of the Alternate Channel PCA Availability IE is given in FIG. 22. The Interpretation field is as proposed for the Interpretation field for the PCA Availability IE in this description. The Channel Number is the channel number for which the device's availability for PCA MAS is advertised.

In one embodiment, an ad-hoc radio communication device within an ad-hoc radio communication devices' group for transmitting OFDM symbols comprises a generating unit configured to generate an advertisement message for device's contention based medium access availability, including in the message, information about time slots the ad-hoc radio communication device would be available for contention based medium access; and a transmitting unit configured to transmit the advertisement message to at least one other ad-hoc radio communication device with which the ad-hoc radio communication device has an established communication connection in a current frequency channel. This embodiment is illustrated in FIG. 25, wherein an ad-hoc radio communication device within an ad-hoc radio communication devices' group comprises a generating unit 2501 and a transmitting unit 2502.

In one embodiment, the advertisement message further comprises information on a frequency hopping pattern or a time shifted version of that frequency hopping pattern for which the device advertises its own availability for contention based medium access, wherein the frequency hopping pattern is with reference to a fixed point of time which may be the start of a Medium Access Slot.

In one embodiment, the advertisement message further comprises information on frequency channel number concerning which the device's availability for contention based medium access is advertised.

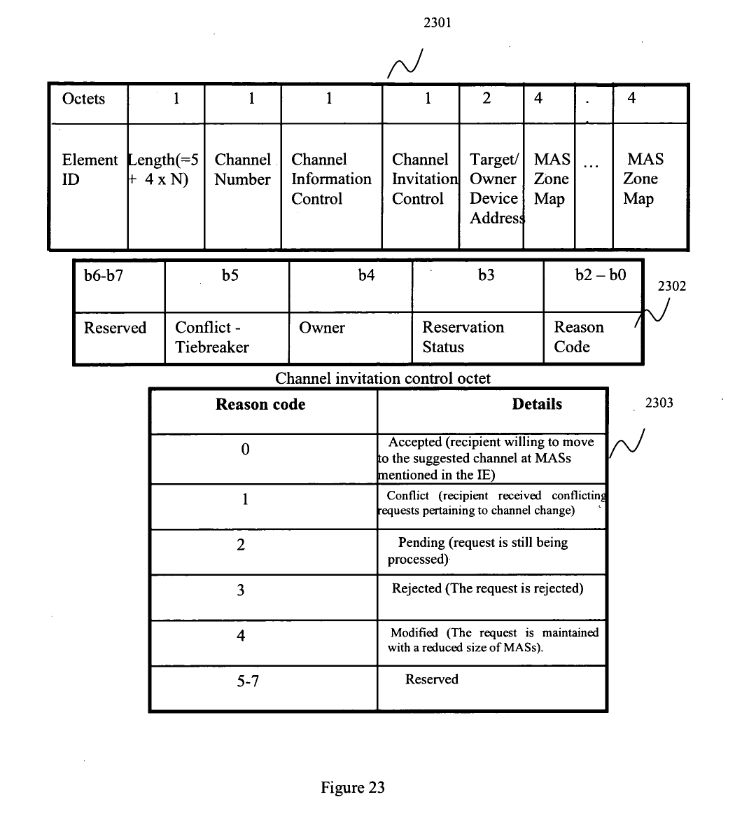

Channel Invitation IE: The format of the Channel Invitation IE is shown in FIG. 23. The Channel Number is the number of the channel that the device sending the IE as an owner is inviting other devices to join. The Channel Information Control octet is the same as the first octet of the Channel Information Control field given with channel IE in this description (FIG. 12), with the interpretation of the TFC offset of the channel to be applicable to the channel that a device sending the Channel Invitation IE as an owner is inviting other devices to join. The Owner/Target Device Address can be a multicast or a unicast address. Table 2301 shows the Channel Invitation IE. Table 2302 shows the Channel Invitation Control field of table 2301 in more detail. Table 2303 shows Reason Code of table 2302 in more detail.

In one embodiment, an ad-hoc radio communication device within an ad-hoc radio communication devices' group for transmitting OFDM symbols comprises a generating unit configured to generate a channel invitation negotiation message to invite other devices in the devices' ad-hoc radio communication group to join the device on a particular channel number during particular time slots; and a transmitting unit configured to transmit the channel invitation negotiation message to at least one other ad-hoc radio communication device with which the ad-hoc radio communication device has an established communication connection in a current frequency channel. This embodiment is illustrated in FIG. 25, wherein an ad-hoc radio communication device within an ad-hoc radio communication devices' group comprises a generating unit 2501 and a transmitting unit 2502.

In one embodiment, the channel invitation negotiation message further comprises information on a frequency hopping pattern or a time shifted version of that frequency hopping pattern on which the device is inviting other devices in the devices' communication group to join; wherein the frequency hopping pattern may be with reference to a fixed point of time which may be the start of a Medium Access Slot.

In one embodiment, the channel invitation negotiation message further comprises information on frequency channel number the device is inviting other devices in the devices' communication group to join.

In one embodiment, the channel invitation negotiation message further comprises information as to whether the device sending the channel invitation message is the originator or the owner of the channel invitation negotiation message.

In one embodiment, one other device that receives a channel invitation negotiation message from an originator or owner responds with a channel invitation negotiation message including information as to whether the one other device is willing to join the originator or the owner of the channel invitation negotiation message on the channel number included in the channel invitation negotiation message from the originator or owner.

In one embodiment, one other device that receives a channel invitation negotiation message from an originator or owner responds with a channel invitation negotiation message including information as to whether the one other device has received conflicting requests regarding channel invitation negotiation messages from other devices, or as to whether the number of time slots included in the channel invitation negotiation message from the owner or the originator has been reduced or changed.

Band Group Availability IE: The format of the Band Group Availability IE is given in FIG. 24. A bit in the band group availability octet is set to one if the corresponding band group is available. Table 2401 shows the Band Group Availability IE. Table 2402 shows the band group availability field of table 2401 in more detail.

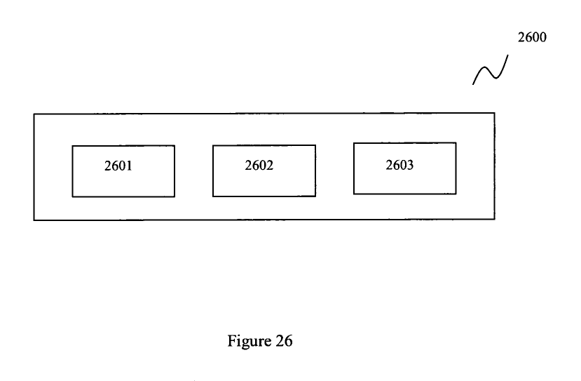

In one embodiment, an ad-hoc radio communication device within an ad-hoc radio communication devices' group for transmitting OFDM symbols is provided which comprises a message generating unit configured to generate a frequency range availability message to inform other devices in the ad-hoc radio communication devices' group as to which frequency ranges are available for use by any of the devices in the devices' ad-hoc radio communication group; and a transmitter unit configured to transmit the frequency range availability message to at least one other ad-hoc radio communication device with which the ad-hoc radio communication device has an established communication connection in a current frequency channel; and a receiver unit to receive messages from other device within the ad-hoc radio communication devices' group. This embodiment is illustrated in FIG. 26. The ad-hoc radio communication device 2600 comprises a message generating unit 2601, a transmitter unit 2602, and a receiver unit 2603.

The control and command frames can be transmitted and received in multiple band groups by a device in the same superframe or in any TFC offset of the channel that a device is capable of transmitting and receiving in. Appropriate device addresses using the same band group and channel are used in all the related control frames. These frames shall be capable of using the Alternate Channel DRP IE instead of DRP IE and Alternate Channel DRP Availability IE instead of DRP Availability IE.

It should be noted that although the description is mainly shown and described based on the current version of ECMA standard (2^{nd} Edition/December 2007), the invention is not limited thereto. For example, the proposed invention is not limited to use with OFDM modulation alone, but also applicable to other modulation schemes such as Single Carrier (SC) modulation.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

In one embodiment, a method for transmitting OFDM symbols by a plurality of ad-hoc radio communication devices in an ad-hoc radio communication devices' group is provided, wherein a first ad-hoc radio communication device of the ad-hoc radio communication devices' group transmits a first OFDM symbol in a first frequency sub-range of a frequency range selected for transmission in accordance with a frequency hopping pattern, the frequency range comprising a plurality of frequency sub-ranges; and in the same transmission time period, a second ad-hoc radio communication device of the ad-hoc radio communication devices' group transmitting a second OFDM symbol in a second frequency sub-range of the frequency range, wherein the second frequency sub-range is different from the first frequency sub-range.

In one embodiment, the frequency hopping pattern is with reference to a fixed point in time. In one embodiment, the fixed point in time is the start of a beacon slot or the start of a Medium Access Slot (MAS).

In one embodiment, the second ad-hoc radio communication device transmits the second OFDM symbol in accordance with a time shifted version of the frequency hopping pattern.

In one embodiment, in the same transmission time period, a third ad-hoc radio communication device of the ad-hoc radio communication devices' group transmits a third OFDM symbol in a third frequency sub-range of the frequency range, wherein the third frequency sub-range is different from the first and second frequency sub-ranges.

In one embodiment, the third ad-hoc radio communication device transmits the third OFDM symbol in accordance with a still larger time shifted version of the frequency hopping pattern.

In one embodiment, the frequency range is a frequency band group, and the frequency sub-range is a frequency band within the frequency band group.

In one embodiment, the frequency band group comprises two to three or more frequency bands. According to one embodiment, the frequency hopping pattern is a Time-Frequency Code (TFC).

According to one embodiment, the number of OFDM symbols that can be transmitted by the plurality of ad-hoc radio communication devices in the ad-hoc radio communication devices' group is limited to the number of frequency sub-ranges of the frequency range.

According to one embodiment, the plurality of ad-hoc radio communication devices in the ad-hoc radio communication devices' group are synchronized.

According to one embodiment, in the frequency range, an OFDM Symbol Transmission Duration (OSTD) of a first OFDM symbol transmission is followed by an OSTD of a second OFDM symbol transmission with no time interval between them, and all the OSTDs within a fixed time period are contiguously aligned starting from a fixed reference point in a fixed time period.

According to one embodiment, the fixed time period is a beacon slot or a Medium Access Slot (MAS), and the fixed reference point is the start of the beacon slot or the start of the MAS.

According to one embodiment, an OSTD includes OFDM symbol transmission time and OFDM frequency sub-range switching time.

According to one embodiment, any device in the ad-hoc radio communication devices' group reserves or uses a default frequency sub-range of the frequency range for transmission according to the frequency hopping pattern.

According to one embodiment, when the times are reserved or selected within the default frequency sub-range of the frequency range for transmission according to the frequency hopping pattern, the device selects another frequency sub-range for transmitting a OFDM symbol.

According to one embodiment, the device selects the other frequency sub-range for transmitting a OFDM symbol in accordance with a time shifted version of the frequency hopping pattern.

According to one embodiment, if times are reserved for the other frequency sub-range of the frequency range in accordance with the time shifted version of the frequency hopping pattern, then the device reserves a different frequency sub-range of the frequency range in accordance with a still larger time shifted version of the frequency hopping pattern.

According to one embodiment, a device in the ad-hoc radio communication devices' group selects a frequency sub-range of the frequency range for transmitting an OFDM symbol. According to one embodiment, the device selects the frequency sub-range in accordance with a random but fixed time shift of the frequency hopping pattern, or a prior fixed time shift of the frequency hopping pattern at every OFDM symbol transmission duration during a fixed time slot. According to one embodiment, the fixed time slot is a beacon slot or a Medium Access Slot.

According to one embodiment, a device in the ad-hoc radio communication device group selects or reserves a frequency sub-range in accordance with a time shifted version of the frequency hopping pattern, the frequency sub-range being different from a frequency sub-range that has been reserved or selected by another device in accordance with the frequency hopping pattern or a time shifted version of the frequency hopping pattern in the ad-hoc radio communication devices' group.

According to one embodiment, if a device that wants to transmit an OFDM symbol in the ad-hoc radio communication device group senses that all the frequency sub-ranges are already reserved or used in accordance with the frequency hopping pattern or all the time shifts of the frequency hopping pattern, the device will select a frequency sub-range in accordance with the frequency hopping pattern or a time shifted version of the frequency hopping pattern that will be first released from being used to transmit the OFDM symbol in accordance with the frequency hopping pattern or the time shifted version of the frequency hopping pattern.

According to one embodiment, a counter clock is applied to the frequency hopping pattern and to each time shifted version of the frequency hopping pattern, and wherein upon the release of a frequency sub-range from being used in accordance with the frequency hopping pattern or a time shifted version of the frequency hopping pattern, the counter clock corresponding to the frequency hopping pattern or that time shifted version of the frequency hopping pattern starts being decremented from a predetermined value, and when the counter clock reaches zero, the device starts to transmit the OFDM symbol at the frequency sub-range in accordance with the frequency hopping pattern or the time shifted version of the frequency hopping pattern.

According to one embodiment, a method for transmitting OFDM symbols by a plurality of ad-hoc radio communication devices in an ad-hoc radio communication devices' group comprises: a first ad-hoc radio communication device of the ad-hoc radio communication devices' group reserving a transmission time period for the transmission of a first OFDM symbol in a first frequency sub-range of a frequency range selected for transmission in accordance with a frequency hopping pattern, the frequency range comprising a plurality of frequency sub-ranges; a second ad-hoc radio communication device of the ad-hoc radio communication devices' group reserving the same transmission time period for the transmission of a second OFDM symbol in a second frequency sub-range of the frequency range, wherein the second frequency sub-range is different from the first frequency sub-range.

According to one embodiment, the frequency hopping pattern is with reference to a fixed time. According to one embodiment, the fixed time is the start of a beacon slot or the start of a Medium Access Slot. According to one embodiment, the second ad-hoc radio communication device reserves the same transmission time period for the transmission of a second OFDM symbol in accordance with a time shifted version of the frequency hopping pattern. According to one embodiment, the frequency range is a frequency band group and the frequency sub-range is a frequency band within the frequency band group. According to one embodiment, the frequency band group comprises two to three or more frequency bands. According to one embodiment, the frequency hopping pattern is a Time-Frequency Code (TFC).

According to one embodiment, an ad-hoc radio communication device within an ad-hoc radio communication group for transmitting OFDM symbols comprises: a selector configured to select a frequency sub-range of a frequency range for transmission in accordance with a frequency hopping pattern, the frequency range comprising a plurality of frequency sub-ranges; a transmitter configured to transmit an OFDM symbol in the selected frequency sub-range in accordance with the frequency hopping pattern; wherein the selector is configured to select the frequency sub-range of the frequency range for transmission such that the device transmits an OFDM symbol at a same transmission time period with another ad-hoc radio communication device that is within the same ad-hoc communication group, wherein the other device uses a different frequency sub-range of the frequency range for transmission.

According to one embodiment, the frequency hopping pattern is with reference to a fixed time. According to one embodiment, the fixed time is the start of a beacon slot or the start of a Medium Access Slot. According to one embodiment, the other device uses the different frequency sub-range of the frequency range for transmission in accordance with the frequency hopping pattern or a time shifted version of the frequency hopping pattern. According to one embodiment, the frequency range is a frequency band group, and the frequency sub-range is a frequency band within the frequency band group. According to one embodiment, the frequency band group comprises two to three or more frequency bands. According to one embodiment, the frequency hopping pattern is a Time-Frequency Code (TFC).

According to one embodiment, the ad-hoc radio communication device further comprises a synchronization circuit, wherein the synchronization circuit is configured to synchronize the device with other devices within the ad-hoc radio communication devices' group. According to one embodiment, in each frequency sub-range, the transmitter is configured to transmit an OFDM symbol such that the OFDM Symbol Transmission Duration (OSTD) of an OFDM symbol transmission follows an OSTD of another OFDM symbol transmission with no time interval between them. According to one further embodiment of the invention, an OSTD includes OFDM symbol transmission time and OFDM frequency sub-range switching time. According to one embodiment, the selector is configured to reserve or use a default frequency sub-range of the frequency range for transmission in accordance with a frequency hopping pattern. According to one embodiment, the frequency hopping pattern is with reference to a fixed time. According to one embodiment, when the times are reserved or selected within the default frequency sub-range in accordance to the frequency hopping pattern, the selector is configured to select another frequency sub-range in accordance with a time shifted version of the frequency hopping pattern for transmitting an OFDM symbol.

According to one embodiment, when the times are reserved or selected within the other frequency sub-range in accordance to the time shifted version of the frequency hopping pattern, the selector is configured to select another frequency sub-range in accordance with a still larger time shifted version of the frequency hopping pattern for transmitting an OFDM symbol. According to one embodiment, the selector is configured to select a frequency sub-range of the frequency range in accordance with a random and fixed time shift of the frequency hopping pattern, or a prior fixed time shift of the frequency hopping pattern at every OFDM symbol transmission duration during a fixed time slot for transmitting OFDM symbol. According to one further embodiment of the invention, the fixed time slot is a beacon slot or a Medium Access Slot.

According to one embodiment, the selector is configured to select a frequency sub-range in accordance with a time shifted version of the frequency hopping pattern, the frequency sub-range being different from a frequency sub-range that has been reserved or selected by another device in the ad-hoc radio communication device group in accordance with the frequency hopping pattern or a time shifted version of the frequency hopping pattern. According to one embodiment, if all the frequency sub-ranges are already reserved or used, the selector is configured to select a frequency sub-range in accordance with the frequency hopping pattern or a time shifted version of the frequency hopping pattern that will be first released from being used in accordance with the frequency hopping pattern or a time shifted version of the frequency hopping pattern to transmit the OFDM symbol. According to one embodiment, the ad-hoc radio communication device further comprises a counter clock applied to the frequency hopping pattern and to each time shifted version of the frequency hopping pattern, wherein upon the release of a frequency sub-range from being used in accordance with the frequency hopping pattern or a time shifted version of the frequency hopping pattern, the counter clock corresponding to the frequency hopping pattern or that time shifted version of the frequency hopping pattern starts being decremented from a predetermined value, and when the counter clock reaches zero, the device starts to transmit the OFDM symbol at the frequency sub-range in accordance with that frequency hopping pattern or that time shifted version of the frequency hopping pattern.

According to one embodiment, a method for transmitting OFDM symbols by a plurality of ad-hoc radio communication devices in an ad-hoc radio communication devices' group comprises: a first ad-hoc radio communication device of the ad-hoc radio communication devices' group transmitting a first OFDM symbol in a first frequency sub-range of a first frequency range selected for transmission in accordance with a frequency hopping pattern, the first frequency range comprising a plurality of frequency sub-ranges; in the same or overlapping transmission time period, a second ad-hoc radio communication device of the ad-hoc radio communication devices' group transmitting a second OFDM symbol in a second frequency sub-range of a second frequency range, in accordance with a different frequency hopping pattern, wherein the second frequency range is different from the first frequency range. According to one embodiment, in the same transmission time period or an overlapping period, other ad-hoc radio communication devices of the ad-hoc radio communication devices' group transmit other OFDM symbols in separate and distinct non over-lapping frequency ranges in accordance with respective different frequency hopping patterns, wherein the non-overlapping distinct frequency ranges used by these other devices are different from the first and second frequency ranges.

According to one embodiment, a frequency range is a frequency band group, and the frequency sub-range is a frequency band within the frequency band group. According to one embodiment, the frequency band group comprises two to three or more frequency bands. According to one embodiment, the frequency hopping pattern is a Time-Frequency Code (TFC).

According to one embodiment, a method for operating an ad-hoc radio communication device in a devices' communication group comprises: generating a channel information message including information about frequency channel number the ad-hoc radio communication device uses to send beacons; and transmitting the channel information message to at least one other ad-hoc radio communication device with which the ad-hoc radio communication device has an established communication connection in a current frequency channel. According to one embodiment, the channel information message further comprises information on a frequency hopping pattern or a time shifted version of that frequency hopping pattern that the device uses to send beacons, wherein the frequency hopping pattern is with reference to a fixed point of time. According to one embodiment, the channel information message further comprises information on number of antennas being used by the device for a fixed period of time. According to one embodiment, the fixed period of time is a superframe and the fixed point of time is the start of a beacon slot or the start of a Medium Access Slot.

According to one embodiment, a method for operating an ad-hoc radio communication device in a devices' communication group comprises: generating a reservation negotiation message including information about time slots the ad-hoc radio communication device is negotiation reservation for; and transmitting the reservation negotiation message to at least one other ad-hoc radio communication device with which the ad-hoc radio communication device has an established communication connection in a current frequency channel.

According to one embodiment, the reservation negotiation message further comprises information on a frequency hopping pattern or a time shifted version of that frequency hopping pattern that the device wishes to seek reservation in for the particular time slots, wherein the frequency hopping pattern may be with reference to a fixed point of time which may be the start of a Medium Access Slot.

According to one embodiment, the reservation negotiation message further comprises information on frequency channel number in which the reservation for the time slots is sought. According to one embodiment, the reservation negotiation message further comprises information on the number of antennas and the type of transmission proposed to be used in the time slots for which reservation is sought.

According to one embodiment, a method for operating an ad-hoc radio communication device in a devices' communication group comprises: generating a reservation availability advertisement message including information about time slots where the ad-hoc radio communication device knows further reservations are possible; and transmitting the reservation availability advertisement message to at least one other ad-hoc radio communication device with which the ad-hoc radio communication device has an established communication connection in a current frequency channel.

According to one embodiment, the reservation availability advertisement message further comprises information on a frequency hopping pattern or a time shifted version of that frequency hopping pattern for which the device advertises reservation availability or availability of time slots for reservation, wherein the frequency hopping pattern may be with reference to a fixed point of time which may be the start of a Medium Access Slot.

According to one embodiment, the reservation availability advertisement message further comprises information on frequency channel number concerning which the reservation availability or availability of time slots is advertised.

According to one embodiment of the invention, a method for operating an ad-hoc radio communication device in a devices' communication group comprises: generating an advertisement message for device's contention based medium access availability, including in the message, information about time slots the ad-hoc radio communication device would be available for contention based medium access; and transmitting the advertisement message to at least one other ad-hoc radio communication device with which the ad-hoc radio communication device has an established communication connection in a current frequency channel.

According to one embodiment, the advertisement message further comprises information on a frequency hopping pattern or a time shifted version of that frequency hopping pattern for which the device advertises its own availability for contention based medium access, wherein the frequency hopping pattern is with reference to a fixed point of time which may be the start of a Medium Access Slot.

According to one embodiment, the advertisement message further comprises information on frequency channel number concerning which the device's availability for contention based medium access is advertised.

According to one embodiment, a method for operating an ad-hoc radio communication device in a devices' communication group comprises: generating a channel invitation negotiation message to invite other devices in the devices' ad-hoc radio communication group to join the device on a particular channel number during particular time slots; and transmitting the channel invitation negotiation message to at least one other ad-hoc radio communication device with which the ad-hoc radio communication device has an established communication connection in a current frequency channel. According to one further embodiment of the invention, the channel invitation negotiation message further comprises information on a frequency hopping pattern or a time shifted version of that frequency hopping pattern on which the device is inviting other devices in the devices' communication group to join; wherein the frequency hopping pattern may be with reference to a fixed point of time which may be the start of a Medium Access Slot.

According to one embodiment, the channel invitation negotiation message further comprises information on frequency channel number the device is inviting other devices in the devices' communication group to join. According to one embodiment, the channel invitation negotiation message further comprises information as to whether the device sending the channel invitation message is the originator or the owner of the channel invitation negotiation message. According to one embodiment, one other device that receives a channel invitation negotiation message from an originator or owner responds with a channel invitation negotiation message including information as to whether the one other device is willing to join the originator or the owner of the channel invitation negotiation message on the channel number included in the channel invitation negotiation message from the originator or owner.

According to one embodiment, one other device that receives a channel invitation negotiation message from an originator or owner responds with a channel invitation negotiation message including information as to whether the one other device has received conflicting requests regarding channel invitation negotiation messages from other devices, or as to whether the number of time slots included in the channel invitation negotiation message from the owner or the originator has been reduced or changed.

According to one embodiment, a method for operating an ad-hoc radio communication device in a devices' communication group comprises: generating a frequency range availability message to inform other devices in the ad-hoc radio communication devices' group as to which frequency ranges are available for use by any of the devices in the devices' ad-hoc radio communication group; transmitting the frequency range availability message to at least one other ad-hoc radio communication device with which the ad-hoc radio communication device has an established communication connection in a current frequency channel. According to one embodiment, the frequency range is a band group.

According to one embodiment, a method for transmitting OFDM symbols by an ad-hoc radio communication device in an ad-hoc radio communication devices' group in a fixed time period comprises the ad-hoc radio communication device of the ad-hoc radio communication devices' group transmitting OFDM symbols in a first frequency range selected for transmission in accordance with a frequency hopping pattern in a first sub-period within the fixed time period, the first frequency range comprising a plurality of frequency sub-ranges; in a second sub-period different from the first sub-period within the above same fixed time period the ad-hoc radio communication device of the ad-hoc radio communication devices' group transmitting OFDM symbols in a second frequency range, in accordance with a different frequency hopping pattern, wherein the second frequency range is different from the first frequency range.

According to one embodiment, the fixed time period is a superframe and the sub-periods are either Medium Access Slots (MASs) or beacon slots. According to one embodiment, a frequency range is a frequency band group. According to one embodiment, the frequency sub-range is a frequency band within a frequency band group. According to one further embodiment of the invention, the frequency band group comprises two to three or more frequency bands, and each frequency band is a frequency sub-range of the band group. According to one embodiment, the frequency hopping pattern is a Time-Frequency Code (TFC). According to one embodiment, the device transmits a default channel beacon in the beacon period of the first frequency range and the device transmits an alternate channel beacon in the second frequency range; a bit in the beacon set to one or a zero to signify if the beacon is an alternate channel beacon or a default channel beacon respectively.

According to one embodiment, an ad-hoc radio communication device within an ad-hoc radio communication devices' group for transmitting OFDM symbols comprises a transmitter configured to transmit OFDM symbols in a first frequency range selected for transmission in accordance with a frequency hopping pattern in a first sub-period within a fixed time period, the first frequency range comprising a plurality of frequency sub-ranges, the transmitter also being configured to, in a second sub-period different from the first sub-period within the above same fixed time period, transmit OFDM symbols in a second frequency range, in accordance with a different frequency hopping pattern, wherein the second frequency range is different from the first frequency range.

According to one embodiment, the fixed time period is a superframe and the sub-periods are either Medium Access Slots (MASs) or beacon slots. According to one embodiment, a frequency range is a frequency band group, and the frequency sub-range is a frequency band within the frequency band group. According to one embodiment, the frequency band group comprises two to three or more frequency bands, and each frequency band is a frequency sub-range of the band group. According to one embodiment, the frequency hopping pattern is a Time-Frequency Code (TFC). According to one embodiment, the device transmits a default channel beacon in the beacon period of the first frequency range and the device transmits an alternate channel beacon in the second frequency range; a bit in the beacon set to one or a zero to signify if the beacon is an alternate channel beacon or a default channel beacon respectively.

According to one embodiment, an ad-hoc radio communication device within an ad-hoc radio communication devices' group for transmitting OFDM symbols comprises: a transmitter to transmit OFDM symbols; a receiver to receive OFDM symbols; wherein the transmitter is configured to transmit a first OFDM symbol in a first frequency sub-range of a first frequency range selected for transmission in accordance with a frequency hopping pattern in the same or overlapping transmission time period when a transmitter of a second ad-hoc radio communication device of the ad-hoc radio communication devices' group transmits a second OFDM symbol in a second frequency sub-range of a second frequency range, in accordance with a different frequency hopping pattern, wherein the first frequency range comprises a plurality of frequency sub-ranges, and the second frequency range is different from the first frequency range.

According to one embodiment, a frequency range is a frequency band group, and the frequency sub-range is a frequency band within the frequency band group. According to one embodiment, the frequency band group comprises two to three or more frequency bands. According to one embodiment, the frequency hopping pattern is a Time-Frequency Code (TFC).

According to one embodiment, an ad-hoc radio communication device within an ad-hoc radio communication devices' group for transmitting OFDM symbols comprises a message generating unit configured to generate a frequency range availability message to inform other devices in the ad-hoc radio communication devices' group as to which frequency ranges are available for use by any of the devices in the devices' ad-hoc radio communication group; a transmitter unit configured to transmit the frequency range availability message to at least one other ad-hoc radio communication device with which the ad-hoc radio communication device has an established communication connection in a current frequency channel; a receiver unit to receive messages from the other device within the ad-hoc radio communication devices' group. According to one embodiment, a frequency range is a frequency band group.

In one embodiment, an ad-hoc radio communication device within an ad-hoc radio communication devices' group for transmitting OFDM symbols comprises a generating unit configured to generate a channel information message including information about frequency channel number the ad-hoc radio communication device uses to send beacons; and a transmitting unit configured to transmit the channel information message to at least one other ad-hoc radio communication device with which the ad-hoc radio communication device has an established communication connection in a current frequency channel.

In one embodiment, the channel information message further comprises information on a frequency hopping pattern or a time shifted version of that frequency hopping pattern that the device uses to send beacons, wherein the frequency hopping pattern is with reference to a fixed point of time.

In one embodiment, the channel information message further comprises information on number of antennas being used by the device for a fixed period of time.

In one embodiment, the fixed period of time is a superframe and the fixed point of time is the start of a beacon slot or the start of a Medium Access Slot.

In one embodiment, an ad-hoc radio communication device within an ad-hoc radio communication devices' group for transmitting OFDM symbols comprises a generating unit configured to generate a reservation negotiation message including information about time slots the ad-hoc radio communication device is negotiation reservation for; and a transmitting unit configured to transmit the reservation negotiation message to at least one other ad-hoc radio communication device with which the ad-hoc radio communication device has an established communication connection in a current frequency channel.

In one embodiment, the reservation negotiation message further comprises information on a frequency hopping pattern or a time shifted version of that frequency hopping pattern that the device wishes to seek reservation in for the particular time slots, wherein the frequency hopping pattern may be with reference to a fixed point of time which may be the start of a Medium Access Slot.

In one embodiment, the reservation negotiation message further comprises information on frequency channel number in which the reservation for the time slots is sought.

In one embodiment, the reservation negotiation message further comprises information on the number of antennas and the type of transmission proposed to be used in the time slots for which reservation is sought.

In one embodiment, an ad-hoc radio communication device within an ad-hoc radio communication devices' group for transmitting OFDM symbols comprises a generating unit configured to generate a reservation availability advertisement message including information about time slots where the ad-hoc radio communication device knows further reservations are possible; and a transmitting unit configured to transmit the reservation availability advertisement message to at least one other ad-hoc radio communication device with which the ad-hoc radio communication device has an established communication connection in a current frequency channel.

In one embodiment, the reservation availability advertisement message further comprises information on a frequency hopping pattern or a time shifted version of that frequency hopping pattern for which the device advertises reservation availability or availability of time slots for reservation, wherein the frequency hopping pattern may be with reference to a fixed point of time which may be the start of a Medium Access Slot.

In one embodiment, the reservation availability advertisement message further comprises information on frequency channel number concerning which the reservation availability or availability of time slots is advertised.

In one embodiment, an ad-hoc radio communication device within an ad-hoc radio communication devices' group for transmitting OFDM symbols comprises a generating unit configured to generate an advertisement message for device's contention based medium access availability, including in the message, information about time slots the ad-hoc radio communication device would be available for contention based medium access; and a transmitting unit configured to transmit the advertisement message to at least one other ad-hoc radio communication device with which the ad-hoc radio communication device has an established communication connection in a current frequency channel.

In one embodiment, the advertisement message further comprises information on a frequency hopping pattern or a time shifted version of that frequency hopping pattern for which the device advertises its own availability for contention based medium access, wherein the frequency hopping pattern is with reference to a fixed point of time which may be the start of a Medium Access Slot.

In one embodiment, the advertisement message further comprises information on frequency channel number concerning which the device's availability for contention based medium access is advertised.

In one embodiment, an ad-hoc radio communication device within an ad-hoc radio communication devices' group for transmitting OFDM symbols comprises a generating unit configured to generate a channel invitation negotiation message to invite other devices in the devices' ad-hoc radio communication group to join the device on a particular channel number during particular time slots; and a transmitting unit configured to transmit the channel invitation negotiation message to at least one other ad-hoc radio communication device with which the ad-hoc radio communication device has an established communication connection in a current frequency channel.

In one embodiment, the channel invitation negotiation message further comprises information on a frequency hopping pattern or a time shifted version of that frequency hopping pattern on which the device is inviting other devices in the devices' communication group to join; wherein the frequency hopping pattern may be with reference to a fixed point of time which may be the start of a Medium Access Slot.

In one embodiment, the channel invitation negotiation message further comprises information on frequency channel number the device is inviting other devices in the devices' communication group to join.

In one embodiment, the channel invitation negotiation message further comprises information as to whether the device sending the channel invitation message is the originator or the owner of the channel invitation negotiation message.

In one embodiment, one other device that receives a channel invitation negotiation message from an originator or owner responds with a channel invitation negotiation message including information as to whether the one other device is willing to join the originator or the owner of the channel invitation negotiation message on the channel number included in the channel invitation negotiation message from the originator or owner.

In one embodiment, one other device that receives a channel invitation negotiation message from an originator or owner responds with a channel invitation negotiation message including information as to whether the one other device has received conflicting requests regarding channel invitation negotiation messages from other devices, or as to whether the number of time slots included in the channel invitation negotiation message from the owner or the originator has been reduced or changed.

In this document, the following documents are cited:
[1] Standard ECMA-368, High Rate Ultra Wideband PHY and MAC Standard, December 2007
[2] Ananth Subramanian, Xiaoming Peng and Francois Chin, “Methods of synchronization for improving WiMedia ultra-wideband connectivity” submitted for US provisional filing.

1. A method for transmitting OFDM symbols by a plurality of ad-hoc radio communication devices in an ad-hoc radio communication devices' group, the method comprising:
a first ad-hoc radio communication device of the ad-hoc radio communication devices' group transmitting a first OFDM symbol in a first frequency sub-range of a frequency range selected for transmission in accordance with a frequency hopping pattern, the frequency range comprising a plurality of frequency sub-ranges;
in the same transmission time period, a second ad-hoc radio communication device of the ad-hoc radio communication devices' group transmitting a second OFDM symbol in a second frequency sub-range of the frequency range, wherein the second frequency sub-range is different from the first frequency sub-range.

2. The method of claim 1, wherein the frequency hopping pattern is with reference to a fixed point in time.

3. The method of claim 2, wherein the fixed point in time is the start of a beacon slot or the start of a Medium Access Slot (MAS).

4. The method of claim 1, wherein the second ad-hoc radio communication device transmits the second OFDM symbol in accordance with a time shifted version of the frequency hopping pattern.

5. The method according to claim 1, further comprising:
in the same transmission time period, a third ad-hoc radio communication device of the ad-hoc radio communication devices' group transmitting a third OFDM symbol in a third frequency sub-range of the frequency range, wherein the third frequency sub-range is different from the first and second frequency sub-ranges.

6. The method of claim 1, wherein the second ad-hoc radio communication device transmits the second OFDM symbol in accordance with a time shifted version of the frequency hopping pattern, and in the same transmission time period, a third ad-hoc radio communication device of the ad-hoc radio communication devices' group transmitting a third OFDM symbol in a third frequency sub-range of the frequency range, wherein the third frequency sub-range is different from the first and second frequency sub-ranges, and wherein the third ad-hoc radio communication device transmits the third OFDM symbol in accordance with a still larger time shifted version of the frequency hopping pattern.

7. The method of claim 1,
wherein the frequency range is a frequency band group, and the frequency sub-range is a frequency band within the frequency band group.

8. The method according to claim 7,
wherein the frequency band group comprises two to three or more frequency bands.

9. The method according to claim 1,
wherein the frequency hopping pattern is a Time-Frequency Code (TFC).

10. The method according to claim 1,
wherein the number of OFDM symbols that can be transmitted by the plurality of ad-hoc radio communication devices in the ad-hoc radio communication devices' group is limited to the number of frequency sub-ranges of the frequency range.

11. The method according to claim 1,
wherein the plurality of ad-hoc radio communication devices in the ad-hoc radio communication devices' group are synchronized.

12. The method according to claim 11, wherein in the frequency range, an OFDM Symbol Transmission Duration (OSTD) of a first OFDM symbol transmission is followed by an OSTD of a second OFDM symbol transmission with no time interval between them, and all the OSTDs within a fixed time period are contiguously aligned starting from a fixed reference point in the fixed time period.

13. The method according to claim 12, wherein the fixed time period is a beacon slot or a Medium Access Slot (MAS), and the fixed reference point is the start of the beacon slot or the start of the MAS.

14. The method according to claim 12,
wherein an OSTD includes OFDM symbol transmission time and OFDM frequency sub-range switching time.

15. The method according to claim 1,
wherein any device in the ad-hoc radio communication devices' group reserves or uses a default frequency sub-range of the frequency range for transmission according to the frequency hopping pattern.

16. The method according to claim 15,
wherein when the times are reserved or selected within the default frequency sub-range of the frequency range for transmission according to the frequency hopping pattern, the device selects another frequency sub-range for transmitting a OFDM symbol.

17. The method of claim 16, wherein the device selects the other frequency sub-range for transmitting a OFDM symbol in accordance with a time shifted version of the frequency hopping pattern.

18. The method of claim 16,
wherein, if times are reserved for the other frequency sub-range of the frequency range in accordance with the time shifted version of the frequency hopping pattern, then the device reserves a different frequency sub-range of the frequency range in accordance with a still larger time shifted version of the frequency hopping pattern.

19. The method of claim 1,
wherein a device in the ad-hoc radio communication devices' group selects a frequency sub-range of the frequency range for transmitting an OFDM symbol.

20. The method of claim 19, wherein the device selects the frequency sub-range in accordance with a random but fixed time shift of the frequency hopping pattern, or a prior fixed time shift of the frequency hopping pattern at every OFDM symbol transmission duration during a fixed time slot.

21. The method of claim 20,
wherein the fixed time slot is a beacon slot or a Medium Access Slot.

22. The method of claim 1,
wherein a device in the ad-hoc radio communication device group selects or reserves a frequency sub-range in accordance with a time shifted version of the frequency hopping pattern, the frequency sub-range being different from a frequency sub-range that has been reserved or selected by another device in accordance with the frequency hopping pattern or a time shifted version of the frequency hopping pattern in the ad-hoc radio communication devices' group.

23. The method of claim 1,
wherein if a device that wants to transmit an OFDM symbol in the ad-hoc radio communication device group senses that all the frequency sub-ranges are already reserved or used in accordance with the frequency hopping pattern or all the time shifts of the frequency hopping pattern, the device will select a frequency sub-range in accordance with the frequency hopping pattern or a time shifted version of the frequency hopping pattern that will be first released from being used to transmit the OFDM symbol in accordance with the frequency hopping pattern or the time shifted version of the frequency hopping pattern.

24. The method of claim 23,
wherein a counter clock is applied to the frequency hopping pattern and to each time shifted version of the frequency hopping pattern, and wherein upon the release of a frequency sub-range from being used in accordance with the frequency hopping pattern or a time shifted version of the frequency hopping pattern, the counter clock corresponding to the frequency hopping pattern or that time shifted version of the frequency hopping pattern starts being decremented from a predetermined value, and when the counter clock reaches zero, the device starts to transmit the OFDM symbol at the frequency sub-range in accordance with the frequency hopping pattern or that time shifted version of the frequency hopping pattern.

25. A method for transmitting OFDM symbols by a plurality of ad-hoc radio communication devices in an ad-hoc radio communication devices' group, the method comprising:
a first ad-hoc radio communication device of the ad-hoc radio communication devices' group reserving a transmission time period for the transmission of a first OFDM symbol in a first frequency sub-range of a frequency range selected for transmission in accordance with a frequency hopping pattern, the frequency range comprising a plurality of frequency sub-ranges;
in the same transmission time period, a second ad-hoc radio communication device of the ad-hoc radio communication devices' group reserving the transmission of a second OFDM symbol in a second frequency sub-range of the frequency range, wherein the second frequency sub-range is different from the first frequency sub-range.

26-31. (canceled)

32. An ad-hoc radio communication device within an ad-hoc radio communication group for transmitting OFDM symbols, comprising:
a selector configured to select a frequency sub-range of a frequency range for transmission in accordance with a frequency hopping pattern, the frequency range comprising a plurality of frequency sub-ranges;
a transmitter configured to transmit an OFDM symbol in the selected frequency sub-range in accordance with the frequency hopping pattern;
wherein the selector is configured to select the frequency sub-range of the frequency range for transmission such that the device transmits an OFDM symbol at a same transmission time period with another ad-hoc radio communication device that is within the same ad-hoc communication group, wherein the other device uses a different frequency sub-range of the frequency range for transmission.

33-50. (canceled)

51. A method for transmitting OFDM symbols by a plurality of ad-hoc radio communication devices in an ad-hoc radio communication devices' group, the method comprising:
a first ad-hoc radio communication device of the ad-hoc radio communication devices' group transmitting a first OFDM symbol in a first frequency sub-range of a first frequency range selected for transmission in accordance with a frequency hopping pattern, the first frequency range comprising a plurality of frequency sub-ranges;
in the same or overlapping transmission time period, a second ad-hoc radio communication device of the ad-hoc radio communication devices' group transmitting a second OFDM symbol in a second frequency sub-range of a second frequency range, in accordance with a different frequency hopping pattern, wherein the second frequency range is different from the first frequency range.

52-55. (canceled)

56. A method for operating an ad-hoc radio communication device in a devices' communication group, the method comprising
generating a channel information message including information about frequency channel number the ad-hoc radio communication device uses to send beacons ; and
transmitting the channel information message to at least one other ad-hoc radio communication device with which the ad-hoc radio communication device has an established communication connection in a current frequency channel.

57. The method of claim 56,
wherein the channel information message further comprises information on a frequency hopping pattern or a time shifted version of that frequency hopping pattern that the device uses to send beacons, wherein the frequency hopping pattern is with reference to a fixed point of time.

58. The method of claim 56,
wherein the channel information message further comprises information on number of antennas being used by the device for a fixed period of time.

59.-69. (canceled)

70. A method for operating an ad-hoc radio communication device in a devices' communication group, the method comprising
generating a channel invitation negotiation message to invite other devices in the devices' ad-hoc radio communication group to join the device on a particular channel number during particular time slots; and
transmitting the channel invitation negotiation message to at least one other ad-hoc radio communication device with which the ad-hoc radio communication device has an established communication connection in a current frequency channel.

71. The method of claim 70,
wherein the channel invitation negotiation message further comprises information on a frequency hopping pattern or a time shifted version of that frequency hopping pattern on which the device is inviting other devices in the devices' communication group to join; wherein the frequency hopping pattern may be with reference to a fixed point of time which may be the start of a Medium Access Slot.

72. The method of claim 70,
wherein the channel invitation negotiation message further comprises information on frequency channel number the device is inviting other devices in the devices' communication group to join.

73. The method of claim 70,
wherein, the channel invitation negotiation message further comprises information as to whether the device sending the channel invitation message is the originator or the owner of the channel invitation negotiation message.

74. The method of claim 70,
wherein, one other device that receives a channel invitation negotiation message from an originator or owner responds with a channel invitation negotiation message including information as to whether the one other device is willing to join the originator or the owner of the channel invitation negotiation message on the channel number included in the channel invitation negotiation message from the originator or owner.

75. (canceled)

76. A method for operating an ad-hoc radio communication device in a devices' communication group, the method comprising
generating a frequency range availability message to inform other devices in the ad-hoc radio communication devices' group as to which frequency ranges are available for use by any of the devices in the devices' ad-hoc radio communication group;
transmitting the frequency range availability message to at least one other ad-hoc radio communication device with which the ad-hoc radio communication device has an established communication connection in a current frequency channel.

77.-90. (canceled)

91. An ad-hoc radio communication device within an ad-hoc radio communication devices' group for transmitting OFDM symbols, comprising
a transmitter to transmit OFDM symbols to other devices of the ad-hoc radio communication devices' group;
a receiver to receive OFDM symbols from other devices of the ad-hoc radio communication devices' group;
wherein the transmitter is configured to transmit a first OFDM symbol in a first frequency sub-range of a first frequency range selected for transmission in accordance with a frequency hopping pattern in the same or overlapping transmission time period when a transmitter of a second ad-hoc radio communication device of the ad-hoc radio communication devices' group transmits a second OFDM symbol in a second frequency sub-range of a second frequency range, in accordance with a different frequency hopping pattern, wherein the first frequency range comprises a plurality of frequency sub-ranges, and the second frequency range is different from the first frequency range.

92.-116. (canceled)
